(19) United States
(12) Patent Application Publication
(10) Pub. No.: US 2010/0239914 A1
(43) Pub. Date: Sep. 23, 2010

(54) CATHODE FOR LITHIUM BATTERY

(75) Inventors: Yuriy V. Mikhaylik, Tucson, AZ (US); Karthikeyan Kumaresan, Tucson, AZ (US)

Correspondence Address: WOLF GREENFIELD & SACKS, P.C., 600 ATLANTIC AVENUE, BOSTON, MA, 02210-2206, US

(73) Assignee: Sion Power Corporation, Tucson, AZ (US)

(21) Appl. No.: 12/727,862

(22) Filed: Mar. 19, 2010

Related U.S. Application Data
(60) Provisional application No. 61/161,529, filed on Mar. 19, 2009.

(51) Int. Cl. H01M 4/583; H01M 4/82

(52) U.S. Cl. 429/231.8; 29/623.1

(57) ABSTRACT

The present invention relates to cathodes used in electrochemical cells. A force, or forces, applied to portions of an electrochemical cell as described in this application can reduce irregularity or roughening of an electrode surface of the cell, improving performance. The cathodes described herein may possess enhanced properties that render them particularly suitable for use in electrochemical cells designed to be charged and/or discharged while a force is applied. In some embodiments, the cathode retains sufficient porosity to charge and discharge effectively when a force is applied to the cell. Cathodes described herein may also comprise relatively high electrolyte-accessible conductive material (e.g., carbon) areas. The cathode may comprise a relatively low ratio of the amount of binder and/or mass of electrolyte to cathode active material (e.g., sulfur) ratio in some instances. In some embodiments, electrochemical cells comprising the cathodes described herein may achieve relatively high specific capacities and/or relatively high discharge current densities. In addition, the cathode described herein may exhibit relatively high cathode active material (e.g., sulfur) utilization during charge and discharge. In still further cases, the electrical conductivity between conductive material in the cathode (e.g., carbon) may be enhanced during the application of the force.

### RELATED APPLICATIONS

This application claims the benefit of U.S. Provisional Patent Application Ser. No. 61/161,529, filed Mar. 19, 2009, entitled “Cathode for Lithium Battery,” by Mikhaylik, et al., the entirety of which is incorporated herein by reference.

### FIELD OF INVENTION

The present invention relates to electrochemical cells, and more specifically, to cathodes used in electrochemical cells.

### BACKGROUND

A typical electrochemical cell has a cathode and an anode which participate in an electrochemical reaction. Some previous electrochemical cells have displayed relatively low utilization of active species in the cells, relatively low charge/discharge efficiencies, and relatively high loss of performance with repeated cycling. In addition, the interaction of the electrolyte and the electrodes has been limited in some cases. For example, binders have been used to provide structural support for electrodes. The addition of binder, however, may limit the performance of the cell by blocking the transport of electrolyte within the electrode.

Accordingly, improved compositions and methods are needed.

### SUMMARY OF THE INVENTION

The present invention relates generally to cathodes used in electrochemical cells. The subject matter of the present invention involves, in some cases, interrelated products, alternative solutions to a particular problem, and/or a plurality of different uses of one or more systems and/or articles.

In one set of embodiments, an electrochemical cell is described. In some embodiments, the electrochemical cell may comprise an anode comprising lithium as an anode active material, the anode having an active surface; an electrolyte; and a cathode comprising carbon and sulfur. The electrochemical cell may be capable, in some cases, of utilizing at least about 70% of the total sulfur in the cell through at least 2 charge and discharge cycles subsequent to a first charge and discharge cycle, wherein 100% utilization corresponds to 1675 mAh per gram of total sulfur in the electrochemical cell.

In some instances, the electrochemical cell may comprise an anode comprising lithium as an anode active material, the anode having an active surface; an electrolyte; and a cathode comprising carbon and sulfur. The electrochemical cell may be capable, in some instances, of utilizing at least about 65% of the total sulfur in the cell through at least 10 charge and discharge cycles subsequent to a first charge and discharge cycle, wherein 100% utilization corresponds to 1675 mAh per gram of total sulfur in the electrochemical cell.

In some embodiments, the electrochemical cell may comprise an anode comprising lithium as an anode active material, the anode having an active surface; an electrolyte; and a cathode comprising carbon and sulfur. The electrochemical cell may be capable, in some cases, of utilizing at least about 60% of the total sulfur in the cell through at least 50 charge and discharge cycles subsequent to a first charge and discharge cycle, wherein 100% utilization corresponds to 1675 mAh per gram of total sulfur in the electrochemical cell.

In some instances, the electrochemical cell may comprise an anode comprising lithium as an anode active material, the anode having an active surface; an electrolyte; and a cathode comprising carbon and sulfur. The electrochemical cell may capable, in some cases, of achieving a charge efficiency of at least about 80% during the first charge and discharge cycle and at least about 80% during the 10th charge and discharge cycle subsequent to the first charge and discharge cycle.

In some embodiments, the electrochemical cell may comprise an anode comprising lithium as an anode active material, the anode having an active surface; an electrolyte; and a cathode comprising carbon and sulfur. The electrochemical cell may be capable, in some cases, of achieving a charge efficiency of at least about 80% during the first charging cycle and at least about 80% during the 50th charging cycle subsequent to the first charge and discharge cycle.

In some embodiments, the electrochemical cell may comprise an anode comprising lithium as an anode active material, the anode having an active surface; an electrolyte; and a cathode comprising carbon and sulfur. In some cases, the electrochemical cell may be capable of utilizing at least about 65% of the total sulfur in the cell during a first charge and discharge cycle, wherein 100% utilization corresponds to 1675 mAh per gram of total sulfur in the electrochemical cell, and the electrochemical cell capacity decreases by less than about 0.2% per charge and discharge cycle over at least 10 cycles subsequent to the first charge and discharge cycle.

In some instances, the electrochemical cell may comprise an anode comprising lithium as an anode active material, the anode having an active surface; an electrolyte; and a cathode comprising carbon and sulfur. In some embodiments, the ratio of the mass of electrolyte in the electrochemical cell to the mass of sulfur in the cathode may be less than about 6:1, and the electrochemical cell may be capable of utilizing at least about 65% of the total sulfur in the cell, wherein 100% utilization corresponds to 1675 mAh per gram of total sulfur in the electrochemical cell.

In some embodiments, the electrochemical cell may comprise an anode comprising lithium as an anode active material, the anode having an active surface; an electrolyte; and a cathode comprising carbon and sulfur. In some instances, the cathode may have an electrolyte accessible carbon area of at least about 1 m² per gram of sulfur in the cathode, and the electrochemical cell may be capable of utilizing at least about 65% of the total sulfur in the cell, wherein 100% utilization corresponds to 1675 mAh per gram of total sulfur in the electrochemical cell.

In some cases, the electrochemical cell comprises an anode comprising lithium as an anode active material, the anode having an active surface; an electrolyte; and a cathode comprising carbon and sulfur. In some embodiments, the cathode may have a porosity of at least about 30% during discharge of the electrochemical cell, and the electrochemical cell may be capable of utilizing at least about 65% of the total sulfur in the cell, wherein 100% utilization corresponds to 1675 mAh per gram of total sulfur in the electrochemical cell.

In some embodiments, the electrochemical cell comprises an anode comprising lithium as an anode active material, the anode having an active surface; an electrolyte; and a cathode comprising carbon and sulfur. In some instances, the cathode may have a void volume of at least about 1 cm³ per gram of sulfur in the cathode, and the electrochemical cell may be capable of utilizing at least about 65% of the total sulfur in the cell, wherein 100% utilization corresponds to 1675 mAh per gram of total sulfur in the electrochemical cell.

In some instances, the electrochemical cell comprises an anode comprising lithium as an anode active material, the anode having an active surface; an electrolyte; and a cathode comprising carbon and sulfur. In some cases, the cathode may contain less than about 20% binder by weight, and the electrochemical cell may be capable of utilizing at least about 65% of the total sulfur in the cell, wherein 100% utilization corresponds to 1675 mAh per gram of total sulfur in the electrochemical cell.

In some embodiments, the electrochemical cell may comprise an anode comprising lithium as an anode active material, the anode having an active surface; an electrolyte; and a cathode comprising carbon and sulfur. In some cases, the electrochemical cell may be capable of achieving a current density of at least about 0.4 mA per square centimeter of the cathode surface during charge or discharge, and the electrochemical cell may be capable of utilizing at least about 65% of the total sulfur in the cell, wherein 100% utilization corresponds to 1675 mAh per gram of total sulfur in the electrochemical cell.

In some cases, the electrochemical cell may comprise an anode comprising lithium as an anode active material, the anode having an active surface; an electrolyte; and a cathode comprising carbon and sulfur. In some embodiments, the electrochemical cell may be capable of achieving a current density of at least about 100 mA per gram of sulfur in the cathode during charge or discharge, and the electrochemical cell may be capable of utilizing at least about 65% of the total sulfur in the cell, wherein 100% utilization corresponds to 1675 mAh per gram of total sulfur in the electrochemical cell.

In some instances, the electrochemical cell may comprise an anode comprising lithium as an anode active material, the anode having an active surface; an electrolyte; and a cathode comprising carbon and sulfur. The electrochemical cell, in some embodiments, may be capable of utilizing at least about 65% of the total sulfur in the cell during the application of an anisotropic force with a component normal to the active surface of the anode defining a pressure of at least about 98 Newtons per square centimeter of the anode active surface, and 100% utilization corresponds to 1675 mAh per gram of total sulfur in the electrochemical cell.

In some embodiments, the electrochemical cell may comprise an anode comprising lithium as an anode active material, the anode having an active surface; an electrolyte; and a cathode comprising carbon and sulfur. In some instances, the electrochemical cell may be capable of achieving a current density of at least about 0.4 mA per square centimeter of the cathode surface during charge or discharge, and the ratio of the mass of electrolyte in the electrochemical cell to the mass of sulfur in the cathode may be less than about 6:1.

In some instances, the electrochemical cell may comprise an anode comprising lithium as an anode active material, the anode having an active surface; an electrolyte; and a cathode comprising carbon and sulfur. In some embodiments, the electrochemical cell may be capable of achieving a current density of at least about 0.4 mA per square centimeter of the cathode surface during charge or discharge, and the cathode may have an electrolyte accessible carbon area of at least about 1 m² per gram of sulfur in the cathode.

In some embodiments, the electrochemical cell may comprise an anode comprising lithium as an anode active material, the anode having an active surface; an electrolyte; and a cathode comprising carbon and sulfur. In some cases, the electrochemical cell may be capable of achieving a current density of at least about 0.4 mA per square centimeter of the cathode surface during charge or discharge, and the cathode may have a porosity of at least about 30% during charge or discharge of the electrochemical cell.

In some cases, the electrochemical cell may comprise an anode comprising lithium as an anode active material, the anode having an active surface; an electrolyte; and a cathode comprising carbon and sulfur. In some embodiments, the electrochemical cell may be capable of achieving a current density of at least about 0.4 mA per square centimeter of the cathode surface during charge or discharge, and the cathode may have a void volume of at least about 1 cm³ per gram of sulfur in the cathode.

In some instances, the electrochemical cell may comprise an anode comprising lithium as an anode active material, the anode having an active surface; an electrolyte; and a cathode comprising carbon and sulfur. In some embodiments, the cathode may contain less than about 20% binder by weight, and the electrochemical cell may be capable of achieving a current density of at least about 0.4 mA per square centimeter of the cathode surface during discharge.

In some cases, the electrochemical cell may comprise an anode comprising lithium as an anode active material, the anode having an active surface; an electrolyte; and a cathode comprising carbon and sulfur. In some instances, the electrochemical cell may be capable of achieving a current density of at least about 100 mA per gram of sulfur in the cathode during charge or discharge, and the ratio of the mass of electrolyte in the electrochemical cell to the mass of sulfur in the cathode may be less than about 6:1.

In some embodiments, the electrochemical cell may comprise an anode comprising lithium as an anode active material, the anode having an active surface; an electrolyte; and a cathode comprising carbon and sulfur. In some embodiments, the electrochemical cell may be capable of achieving a current density of at least about 100 mA per gram of sulfur in the cathode during charge or discharge, and the cathode may have an electrolyte accessible carbon area of at least about 1 m² per gram of sulfur in the cathode.

In some instances, the electrochemical cell may comprise an anode comprising lithium as an anode active material, the anode having an active surface; an electrolyte; and a cathode comprising carbon and sulfur. In some cases, the electrochemical cell may be capable of achieving a current density of at least about 100 mA per gram of sulfur in the cathode during charge or discharge, and the cathode may have a porosity of at least about 30% during charge or discharge of the electrochemical cell.

In some embodiments, the electrochemical cell may comprise an anode comprising lithium as an anode active material, the anode having an active surface; an electrolyte; and a cathode comprising carbon and sulfur. In some cases, the electrochemical cell may be capable of achieving a current density of at least about 100 mA per gram of sulfur in the cathode during charge or discharge, and the cathode may have a void volume of at least about 1 cm³ per gram of sulfur in the cathode.

In some cases, the electrochemical cell may comprise an anode comprising lithium as an anode active material, the anode having an active surface; an electrolyte; and a cathode comprising carbon and sulfur. In some embodiments, the cathode may contain less than about 20% binder by weight, and the electrochemical cell may be capable of achieving a current density of at least about 100 mA per gram of sulfur in the cathode during charge or discharge.

In some instances, the electrochemical cell may comprise an anode comprising lithium as an anode active material, the anode having an active surface; an electrolyte; and a cathode comprising carbon and sulfur. In some embodiments, the cathode may have an electrolyte accessible carbon area of at least about 1 m² per gram of sulfur in the cathode during the application of an anisotropic force with a component normal to the active surface of the anode defining a pressure of at least about 98 Newtons per square centimeter of the anode active surface.

In some embodiments, the electrochemical cell may comprise an anode comprising lithium as an anode active material, the anode having an active surface; an electrolyte; and a cathode comprising carbon and sulfur. In some embodiments, the cathode may have a porosity of at least about 30% during the application of an anisotropic force with a component normal to the active surface of the anode defining a pressure of at least about 98 Newtons per square centimeter of the anode active surface.

In some instances, the electrochemical cell may comprise an anode comprising lithium as an anode active material, the anode having an active surface; an electrolyte; and a cathode comprising carbon and sulfur. In some embodiments, the cathode may have a void volume of at least about 1 cm³ per gram of sulfur in the cathode during the application of an anisotropic force with a component normal to the active surface of the anode defining a pressure of at least about 98 Newtons per square centimeter of the anode active surface.

In some embodiments, a method of making an electrochemical cell is described. In some instances the method of making an electrochemical cell may comprise providing a cathode comprising sulfur; providing an anode comprising lithium, the anode having an active surface; applying an anisotropic force component normal to the active surface of the anode; and subsequent to the application of the anisotropic force component, adding a fluid electrolyte such that the electrolyte is in electrochemical communication with the cathode and the anode.

Other aspects, embodiments and features of the invention will become apparent from the following detailed description when considered in conjunction with the accompanying drawings. The accompanying figures are schematic and are not intended to be drawn to scale. For purposes of clarity, not every component is labeled in every figure, nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is a schematic illustration of an electrochemical cell, according to one set of embodiments;

FIG. 2 is a schematic illustration of an electrochemical cell, according to another set of embodiments;

FIG. 3 is a schematic illustration of an electrochemical cell, according to yet another set of embodiments;

FIG. 4 is a schematic illustration of an electrochemical cell stack, according to another set of embodiments;

FIG. 5 includes a plot of specific discharge capacity as a function of the number of cycles, for one set of embodiments;

FIG. 6 includes, according to one set of embodiments, a plot of specific capacity and available sulfur as a function of the number of charge and discharge cycles; and

FIG. 7 includes a plot of voltage as a function of specific capacity, according to one set of embodiments.

### DETAILED DESCRIPTION

The present invention relates to cathodes used in electrochemical cells and other devices having overall arrangements, including cathode arrangements as described herein, to provide good performance. Typical cathodes used in lithium metal rechargeable batteries include a carbon-based component, sulfur, and a binder or other material of some sort to facilitate internal cohesion of the cathode. U.S. Patent Publication No. 2010/0035128 to Scordilis-Kelley et al. filed on Aug. 4, 2009, entitled “Application of Force in Electrochemical Cells,” (which is incorporated herein by reference in its entirety) describes the application of pressure in electrochemical cells for improved electrode chemistry, morphology, and/or other characteristic which can improve performance. The present invention involves, in one aspect, the recognition that application of pressure to a cathode before and/or during use can reduce the need for binder or other adhesive which can increase the overall surface area of carbon available for facilitating both internal electrode conductivity and electrical communication with sulfur, and with electrolyte to which the cathode is exposed. Thus, even if void volume of a cathode is reduced by application of pressure (i.e., reduction of a volume within the cathode which can be taken up by electrolyte), relative to an essentially identical cathode absent application of this pressure, performance of the cathode and an overall device utilizing the cathode can be improved. The cathodes described herein may possess enhanced properties that render them particularly suitable for use in electrochemical cells designed to be charged and/or discharged while a force is applied. The cathodes described herein retain their mechanical integrity when charged and/or discharged during the application of an anisotropic force (e.g., defining a pressure of about 196 Newtons per square centimeter or greater). In some embodiments, the cathode retains sufficient porosity to charge and discharge effectively when a force is applied to the cell. Cathodes described herein may also comprise relatively high electrolyte-accessible conductive material (e.g., carbon) areas. The cathode may comprise a relatively low ratio of the amount of binder and/or mass of electrolyte to cathode active material (e.g., sulfur) ratio in some instances. In some embodiments, electrochemical cells comprising the cathodes described herein may achieve relatively high specific capacities and/or relatively high discharge current densities. In addition, the cathodes described herein may exhibit relatively high cathode active material (e.g., sulfur) utilization during charge and discharge. In still further cases, the electrical conductivity between conductive material in the cathode (e.g., carbon) may be enhanced during the application of the force.

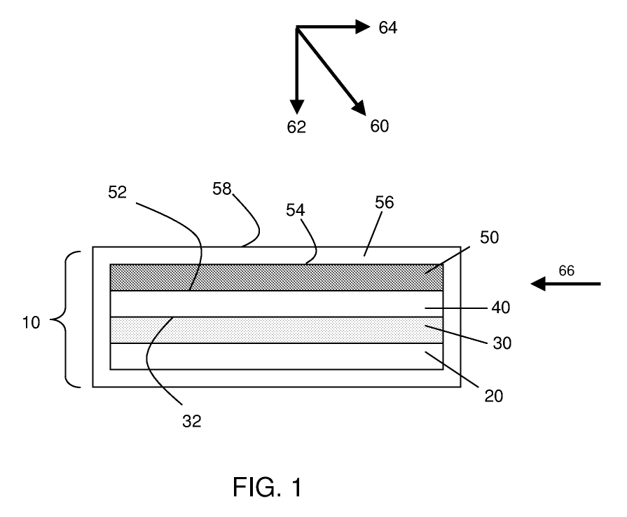

Although the present invention can find use in a wide variety of electrochemical devices, an example of one such device is provided in FIG. 1 for illustrative purposes only. In FIG. 1, a general embodiment of an electrochemical cell can include a cathode, an anode, and an electrolyte layer in electrochemical communication with the cathode and the anode. In FIG. 1, cell 10 includes a cathode 30 that can be formed, for example, on a substantially planar surface of substrate 20. While the cathode and substrate in FIG. 1 are shown as having a planar configuration, other embodiments may include non-planar configurations, as will be described later. The cathode may comprise a variety of cathode active materials. As used herein, the term “cathode active material” refers to any electrochemically active species associated with the cathode. For example, the cathode may comprise a sulfur-containing material, wherein sulfur is the cathode active material. Other examples of cathode active materials are described more fully below.

In some embodiments, cathode 30 comprises at least one active surface (e.g., surface 32). As used herein, the term “active surface” is used to describe a surface of an electrode that is in physical contact with the electrolyte and at which electrochemical reactions may take place. An electrolyte 40 (e.g., comprising a porous separator material) can be formed adjacent to the cathode 30. An anode layer 50 can be formed adjacent electrolyte 40 and may be in electrical communication with the cathode 30. Optionally, the cell may also include, in some embodiments, containment structure 56.

The anode may comprise a variety of anode active materials. As used herein, the term “anode active material” refers to any electrochemically active species associated with the anode. For example, the anode may comprise a lithium-containing material, wherein lithium is the anode active material. Other examples of anode active materials are described more fully below. In some embodiments, anode 50 comprises at least one active surface (e.g., surface 52). The anode 50 may also be formed on an electrolyte layer positioned on cathode 30 via electrolyte 40. Of course, the orientation of the components can be varied, and it should be understood that there are other embodiments in which the orientation of the layers is varied such that, for example, the anode layer or the electrolyte layer is first formed on the substrate. Optionally, additional layers (not shown), such as a multi-layer structure that protects an electroactive material (e.g., an electrode) from the electrolyte, may be present, as described in more detail in U.S. patent application Ser. No. 11/400,781, published as U.S. Patent Publication 2007/0221265, filed Apr. 6, 2006, entitled, “Rechargeable Lithium/Water, Lithium/Air Batteries” to Affinito et al., which is incorporated herein by reference in its entirety. Additionally, non-planar arrangements, arrangements with proportions of materials different than those shown, and other alternative arrangements are useful in connection with the present invention. A typical electrochemical cell also would include, of course, current collectors, external circuitry, housing structure, and the like. Those of ordinary skill in the art are well aware of the many arrangements that can be utilized with the general schematic arrangement as shown in the figures and described herein.

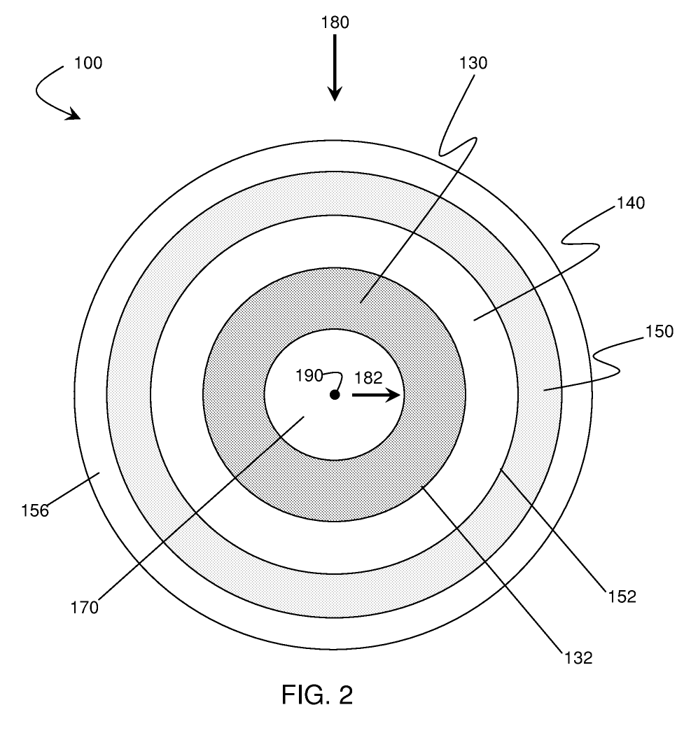

While FIG. 1 illustrates an electrochemical cell arranged in a stacked configuration, it is to be understood that any electrochemical cell arrangement can be constructed, employing the principles of the present invention, in any configuration. For example, FIG. 2 illustrates a cross-sectional view of an electrochemical cell arranged as a cylinder. In the embodiment shown in FIG. 2, cell 100 includes an electrode 130, an electrolyte 140, and electrode 150. In some embodiments, electrode 130 may comprise an anode while electrode 150 may comprise a cathode, while in other embodiments, their order may be reversed. Optionally, the cell may contain core 170 which can be solid, hollow, or contain one or more channels. Cell 100 also includes active surfaces 132 and 152. Optionally, the cell may also include, in some embodiments, containment structure 156. As shown in FIG. 2, electrode 130 is formed on core 170, electrolyte 140 is formed on electrode 130, and electrode 150 is formed on electrolyte 140. However, in some embodiments, electrode 130 may be proximate core 170, electrolyte 140 may be proximate electrode 130, and/or electrode 150 may be proximate electrolyte 140, optionally including one or more intervening sections of material between components. In one set of embodiments, electrode 130 may at least partially surround core 170, electrolyte 140 may at least partially surround electrode 130, and/or electrode 150 may at least partially surround electrolyte 140. As used herein, a first entity is “at least partially surrounded” by a second entity if a closed loop can be drawn around the first entity through only the second entity, and does not imply that the first entity is necessarily completely encapsulated by the second entity.

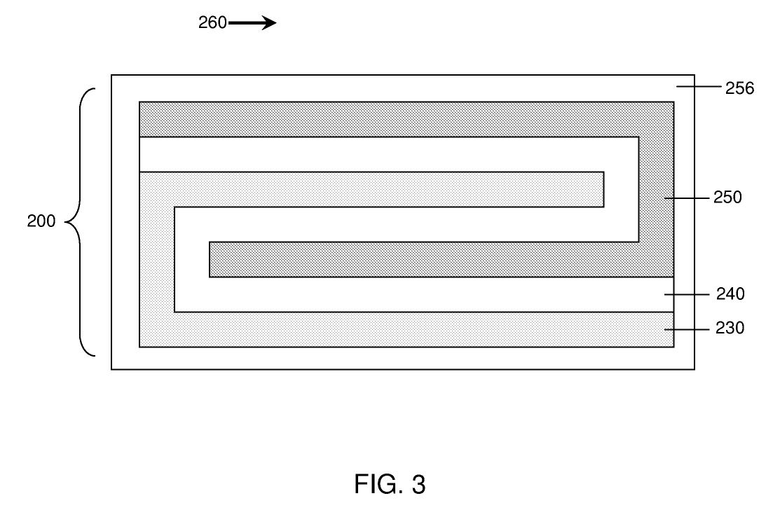

In another set of embodiments, illustrated in FIG. 3, the electrochemical cell is in the shape of a folded stack. The cell 200 illustrated in FIG. 3 comprises electrolyte 240 separating anode 230 and cathode 250. The electrochemical cell in FIG. 3 comprises an electrolyte including three folded planes parallel to arrow 260. In other embodiments, electrochemical cells may comprise electrolytes including any number of folded planes parallel to arrow 260. Optionally, the cell may also include, in some embodiments, containment structure 256. In addition to the shapes illustrated in FIGS. 1-3, the electrochemical cells described herein may be of any other shape including, but not limited to, prisms (e.g., triangular prisms, rectangular prisms, etc.), “Swiss-rolls,” non-planar stacks, etc. Additional configurations are described in U.S. patent application Ser. No. 11/400,025, published as U.S. Patent Publication 2007/0224502, filed Apr. 6, 2006, entitled, “Electrode Protection in both Aqueous and Non-Aqueous Electrochemical Cells, including Rechargeable Lithium Batteries,” to Affinito et al., which is incorporated herein by reference in its entirety.

Cathodes of the present invention may comprise one or more properties that render them effective in delivering enhanced performance. In some instances, the cathodes may exhibit one or more of the properties outlined below during the application of an anisotropic force, the magnitude of which may lie within any of the ranges discussed later.

The cathode may comprise a variety of cathode active materials. In some embodiments, electroactive materials for use as cathode active materials in electrochemical cells described herein include electroactive sulfur-containing materials. “Electroactive sulfur-containing materials,” as used herein, refers to cathode active materials which comprise the element sulfur in any form, wherein the electrochemical activity involves the oxidation or reduction of sulfur atoms or moieties. As an example, the electroactive sulfur-containing material may comprise elemental sulfur (e.g., S₈). In another embodiment, the electroactive sulfur-containing material comprises a mixture of elemental sulfur and a sulfur-containing polymer. Thus, suitable electroactive sulfur-containing materials may include, but are not limited to, elemental sulfur, polysulfides of alkali metals, and organic materials comprising sulfur atoms and carbon atoms, which may or may not be polymeric. Suitable organic materials include those further comprising heteroatoms, conductive polymer segments, composites, and conductive polymers.

Examples of sulfur-containing polymers include those described in: U.S. Pat. Nos. 5,601,947 and 5,690,702 to Skotheim et al.; U.S. Pat. Nos. 5,529,860 and 6,117,590 to Skotheim et al.; U.S. Pat. No. 6,201,100 issued Mar. 13, 2001, to Gorkovenko et al. of the common assignee, and PCT Publication No. WO 99/33130. Other suitable electroactive sulfur-containing materials comprising polysulfide linkages are described in U.S. Pat. No. 5,441,831 to Skotheim et al.; U.S. Pat. No. 4,664,991 to Perichaud et al., and in U.S. Pat. Nos. 5,723,230, 5,783,330, 5,792,575 and 5,882,819 to Naoi et al. Still further examples of electroactive sulfur-containing materials include those comprising disulfide groups as described, for example in, U.S. Pat. No. 4,739,018 to Armand et al.; U.S. Pat. Nos. 4,833,048 and 4,917,974, both to De Jonghe et al.; U.S. Pat. Nos. 5,162,175 and 5,516,598, both to Visco et al.; and U.S. Pat. No. 5,324,599 to Oyama et al.

While sulfur, as the cathode active species, is described predominately, it is to be understood that wherever sulfur is described as the cathode active species herein, any suitable cathode active species may be used. Those of ordinary skill in the art will appreciate this and will be able to select species (e.g., from the list described below) for such use.

In some embodiments, the cathodes described herein may comprise carbon. Carbon may, for example, be used as an electrical conductor within the cathode (e.g., as an electrolyte-accessible conductive material). Suitable sources of carbon for use in the cathode include, for example, graphite (from Fluka, Timcal, etc), XE-2 (Evonic Degussa GmbH, Germany), carbon black (Sid-Richardson Inc, Shawnigan Chemical Company), and Ketjen 600 carbon (Akzo Nobel, USA).

Cathodes described herein may exhibit relatively high porosities. In some cases, the porosity of the cathode may be at least about 30%, at least about 40%, at least about 50%, at least about 60%, at least about 70%, at least about 80%, or at least about 90%. Such porosities may be retained, in some cases, while an anisotropic force (e.g., defining a pressure of between about 4.9 and about 196 Newtons per square centimeter , or any of the ranges outlined below) is applied to the electrochemical cell. As used herein, the “porosity” of an electrode (e.g., the cathode) is defined as the void volume of the electrode divided by the volume within the outer boundary of the electrode, and is expressed as a percentage. “Void volume” is used to refer to portions of the cathode that are not occupied by cathode active material (e.g., sulfur), conductive material (e.g., carbon), binder, or other materials that provide structural support. The void volume within the cathode may comprise pores in the cathode as well as interstices between aggregates of the cathode material. Void volume may be occupied by electrolyte, gases, or other non-cathode materials. In some embodiments, the void volume of the cathode may be at least about 1, at least about 2, at least about 4, or at least about 8 cm³ per gram of cathode active material (e.g., sulfur) in the cathode. In some instances, the void volume may comprise pores with relatively large diameters. For example, in some embodiments, pores of a diameter of at least about 200 nm constitute at least about 50% of the void volume in the cathode.

As noted above, one aspect of the invention involves the discovery that compressing a cathode to facilitate cathode integrity, where the cathode has relatively less binder or adhesive than otherwise might be required to maintain integrity, can improve performance of the cathode and/or a device into which the cathode is incorporated. This improvement can be realized even if void volume of the cathode (and/or the relative amount of electrolyte present in the cathode during use) is reduced. It can also be useful, in combination with the invention, to select a cathode that is resistant to compression to enhance the performance of the cell relative to cells in which the cathode is significantly compressible. For example, using a compression resistant cathode may help maintain high porosities or void volumes during the application of an anisotropic force to the cell. Not wishing to be bound by any theory, the use of elastic, relatively highly compressible cathodes may result in the evacuation of liquid electrolyte during the application of the anisotropic force. The evacuation of liquid electrolyte from the cathode may result in decreased power output during the operation of the electrochemical cell. The use of compressible cathodes may cause a decrease in power output from the electrochemical cell even when the anisotropic force is relatively small (e.g., an anisotropic force defining a pressure of about 68.6 Newtons per square centimeter) or when the anisotropic force is of another magnitude, for example, as noted below with reference to limits and ranges of the component of the anisotropic force normal to the anode active surface. The degree of compressibility can be correlated to a change in porosity, i.e., change in void volume of the cathode, during application of a compressive force. In some embodiments, it may be desirable to limit the change in porosity of the cathode during the operation of the cell. For example, in some embodiments of the invention, the porosity of the cathode may be decreased during operation of the cell by less than about 10%, less than about 6%, less than about 4%, less than about 2%, less than about 1%, less than about 0.5%, less than about 0.1%, or lower. That is, during use of the cell, a compressive force experienced by the cathode may reduce the total void volume, or total volume otherwise accessible by the electrolyte, by percentages noted above, where the cathode is fabricated to provide suitable resistance to compression. Electrochemical cells and other devices comprising cathodes described herein may achieve high levels of performance despite having lower porosities during the application of a force than would be observed absent the force.

The stiffness of the cathode (resistance to compressibility) may be enhanced using a variety of methods. In some embodiments, the cathode may comprise one or more binder materials (e.g., polymers, porous silica sol-gel, etc.) which may, among other functions, provide rigidity. Examples of suitable binders for use in cathodes described herein include, for example, polyvinyl alcohol (PVOH), polyvinylidine fluoride and its derivatives, hydrocarbons, polyethylene, polystyrene, polyethylene oxide and any polymers including hydrocarbon fragments and heteroatoms. The amount of binder within the cathode may be relatively low in some cases. For example, the cathode may contain less than about 20%, less than about 10%, less than about 5%, less than about 2%, or less than about 1% binder by weight in some embodiments. The use of a relatively low amount of binder may allow for improved fluid communication between the electrolyte and the electrode active materials (cathode active material such as sulfur or anode active material such as lithium) and/or between the electrolyte and the electrode conductive material. In addition, the use of a low amount of binder may lead to improved contact between the electrode active material and the electrode conductive material (e.g., carbon) or improved contact within the electrode conductive material itself (e.g., carbon-carbon contact).

In some embodiments, an inherently rigid cathode may be produced by infusing active material (e.g., reticulated Ni foam) into a thin and light superstructure.

The type of electrolyte and the size of the pores in the cathode may be together selected such that the resulting capillary forces produced by the interaction of the electrolyte and the cathode pores resist the deformation of the cathode. This effect may be particularly useful, for example, in small electrochemical cells. As another example, the stiffness of the cathode may be enhanced by incorporating reinforcement fibers (e.g., to connect carbon particles) into the cathode.

In some embodiments, the cathode comprises a relatively large electrolyte accessible conductive material area. As used herein, “electrolyte accessible conductive material area” is used to refer to the total surface area of the conductive material (e.g., carbon) that can be contacted by electrolyte. For example, electrolyte accessible conductive material area may comprise conductive material surface area within the pores of the cathode, conductive material surface area on the external surface of the cathode, etc. In some instances, electrolyte accessible conductive material area is not obstructed by binder or other materials. In addition, in some embodiments, electrolyte accessible conductive material area does not include portions of the conductive material that reside within pores that restrict electrolyte flow due to surface tension effects. In some cases, the cathode comprises an electrolyte accessible conductive material area (e.g., an electrolyte accessible carbon area) of at least about 1 m², at least about 5 m², at least about 10 m², at least about 20 m², at least about 50 m², or at least about 100 m² per gram of cathode active material (e.g., sulfur) in the cathode.

Electrochemical cells described herein may make use of a relatively low mass of electrolyte relative to the mass of the cathode active material. For example, in some instances, the ratio of electrolyte to cathode active material (e.g., sulfur), by mass, within the electrochemical cell is less than about 6:1, less than about 5:1, less than about 4:1, or less than about 3:1.

Electrochemical cells using the cathodes described herein may be capable of achieving enhanced performance. In some embodiments, the electrochemical cell may exhibit high electrode active species utilization. As used herein, “utilization” refers to the extent to which the cathode active material (e.g., sulfur) within a cell reacts to form desirable reaction products, such that the electrochemical performance (as measured by the discharge capacity) is enhanced. For example, an electrochemical cell is said to utilize 100% of the total sulfur in the cell when all of the sulfur in the cell is completely converted to the desired reaction product (e.g., S²⁻ in the case of sulfur as the cathode active material), thus providing the theoretical discharge capacity of 1675 mAh/g of total sulfur in the cell. It is to be understood that wherever “sulfur” is used as an exemplary cathode active material, any other cathode active material suitable for use with the invention can be substituted. The theoretical capacity of any cathode active material can be calculated by the following formula:

$$Q = \frac{n F}{3600 M}$$

wherein,

Q=Theoretical capacity, Ah/g (ampere hour per gram)

n=number of electrons involved in the desired electrochemical reaction,

F=Faraday constant, 96485 C/equi,

M=Molecular mass of cathode active material, gram

3600=Number of seconds in one hour.

Those of ordinary skill in the art would be able to calculate the active material theoretical capacity and compare it to the experimental active material capacity for a particular material to determine whether or not the experimental capacity is at least some percent (e.g., 60%), or greater, of the theoretical capacity. For example, when elemental sulfur (S) is used as the cathode active material and S²⁻ is the desired reaction product, the theoretical capacity is 1675 mAh/g. That is, a cell is said to utilize 100% of the total sulfur in the cell when it produces 1675 mAh/g of total sulfur in the cell, 90% of the total sulfur in the cell when it produces 1507.5 mAh/g of total sulfur in the cell, 60% of the total sulfur in the cell when it produces 1005 mAh/g of total sulfur in the cell, and 50% of the total sulfur in the cell when it produces 837.5 mAh/g of total sulfur in the cell.

In some embodiments, it is possible for the amount of sulfur (or other active material) in the region of the cell that is enclosed by the cathode and anode (“available” sulfur) to be less than that of the total sulfur in the cell. In some cases the electrolyte may be located both in the region enclosed by the anode and cathode and the region not enclosed by the cathode and anode. For example, during charge/discharge cycles under pressure, it is possible for the un-reacted species in the region enclosed by anode and cathode to move out either by diffusion or by the movement of the electrolyte. The procedure to estimate the amount of sulfur in the region enclosed by the cathode and anode (“available” sulfur) is described in Example 4, in one set of embodiments. The utilization expressed based on this “available” sulfur is the measure of the ability of the cathode structure to facilitate the conversion of the sulfur in the region enclosed between the cathode and anode to desirable reaction product (e.g., S²⁻ in the case of sulfur as the cathode active material). That is, if all the sulfur available in the region enclosed between the cathode and anode is completely converted to desired reaction product, then the cell will be said to utilize 100% of the available sulfur, and will produce 1675 mAh/g of available sulfur.

In some embodiments, the cell can be designed in such a way that either all of the electrolyte is located in between the region enclosed by the anode and cathode or the transport of un-reacted species from the enclosed region to the outside is completely eliminated. For such embodiments, the utilization expressed as mAh/g of available sulfur will be equal to that expressed as mAh/g of total sulfur in the cell.

Sulfur utilization may vary with the discharge current applied to the cell, among other things. In some embodiments, sulfur utilization at low discharge rates may be higher than sulfur utilization at high discharge rates. In some embodiments, the cell is capable of utilizing at least about 60%, at least about 65%, at least about 70%, at least about 75%, at least about 80%, at least about 85%, at least about 90%, or at least about 92% of the total sulfur in the cell over at least one charge and discharge cycle. In some embodiments, the cell is capable of utilizing at least about 60%, at least about 65%, at least about 70%, at least about 75%, at least about 80%, at least about 85%, at least about 90%, or at least about 92% of the available sulfur over at least one charge and discharge cycle.

The electrochemical cells described herein may be operated using relatively high discharge current densities, in some cases. As used herein, the “discharge current density” refers to the discharge current between the electrodes, divided by the area of the electrode over which the discharge occurs, as measured perpendicular to the direction of the current. For the purposes of discharge current density, the area of the electrode does not include the total exposed surface area of the electrode, but rather, refers to an imaginary plane drawn along the electrode surface perpendicular to the direction of the current. In some embodiments, the electrochemical cells may be operated at a discharge current density of at least about 0.1 mA/cm², at least about 0.2 mA/cm², at least about 0.4 mA/cm² of the cathode surface, or higher. The cells described herein may also be operated, in some cases, at a high discharge current per unit mass of active material. For example, the discharge current may be at least about 100, at least about 200, at least about 300, at least about 400, or at least about 500 mA per gram of sulfur in the cathode, or higher.

In some cases, the utilization rates of electrochemical cells described herein may remain relatively high through a relatively large number of charge and discharge cycles. As used herein, a “charge and discharge cycle” refers to the process by which a cell is charged from 0% to 100% state of charge (SOC) and discharged from 100% back to 0% SOC. In some embodiments, the electrochemical cell may be capable of utilizing at least about 60%, at least about 65%, at least about 70%, at least about 75%, at least about 80%, at least about 85%, or at least about 90% of the sulfur (e.g., total sulfur in the cell, available sulfur) through at least a first charge and discharge cycle and at least about 1, 2, 10, 20, 30, 50, 75, 100, 125, or 135 charge and discharge cycles subsequent to the first charge and discharge cycle. In certain embodiments, electrochemical cells of the present invention will cycle at least 1 time, at least 2 times, at least 10 times, at least 20 times, at least 30 times, at least 50 times, at least 75 times, at least 100 times, at least 125 times, or at least 135 times subsequent to a first charge and discharge cycle with each cycle having a sulfur utilization (measured as a fraction of 1675 mAh/g sulfur (e.g., total sulfur in the cell, available sulfur) output during the discharge phase of the cycle) of at least about 40-50%, at least about 50-60%, at least about 40-60%, at least about 40-80%, at least about 60-70%, at least about 70%, at least about 70-80%, at least about 80%, at least about 80-90%, or at least about 90% when discharged at a moderately high discharge current of at least about 100 mA/g of sulfur (e.g., a discharge current between 100-200 mA/g, between 200-300 mA/g, between 300-400 mA/g, or between 400-500 mA/g).

Some of the electrochemical cells described herein may maintain capacity over a relatively large number of charge and discharge cycles. For example, in some cases, the electrochemical cell capacity decreases by less than about 0.2% per charge and discharge cycle over at least about 2, at least about 10, at least about 20, at least about 30, at least about 50, at least about 75, at least about 100, at least about 125, or at least about 135 cycles subsequent to a first charge and discharge cycle.

In some embodiments, the electrochemical cells described herein may achieve relatively high charge efficiencies over a large number of cycles. As used herein, the “charge efficiency” of the Nth cycle is calculated as the discharge capacity of the (N+1)th cycle divided by the charge capacity of the Nth cycle (where N is an integer), and is expressed as a percentage. In some cases, electrochemical cells may achieve charge efficiencies of at least about 60%, at least about 70%, at least about 80%, at least about 90%, at least about 95%, at least about 97%, at least about 98%, at least about 99%, at least about 99.5%, or at least about 99.9% for the first cycle. In some embodiments, charge efficiencies of at least about 60%, at least about 70%, at least about 80%, at least about 90%, at least about 97%, at least about 98%, at least about 99%, at least about 99.5%, or at least about 99.9% may be achieved for the 10th, 20th, 30th, 50th, 75th, 100^{th}, 125th, or 135th cycles subsequent to a first charge and discharge cycle.

As mentioned above, some embodiments may include electrochemical devices in which the application of force is used to enhance the performance of the device. For example, the force may provide improved electrical conductivity between conductive material in an electrode (e.g., carbon in a cathode). The anisotropic force may, in some cases, improve the structural rigidity of an electrode (e.g., the cathode), for example, when a low amount of binder is employed. In some instances, the application of force to the electrochemical cell may reduce the amount of roughening of one or more surfaces of one or more electrodes which may improve the cycling lifetime and performance of the cell. Any of the performance metrics outlined above may be achieved, alone or in combination with each other, while an anisotropic force is applied to the electrochemical cell (e.g., during charge and/or discharge of the cell). The magnitude of the anisotropic force may lie within any of the ranges mentioned below.

In some embodiments, the force comprises an anisotropic force with a component normal to the active surface of the anode. In the case of a planar surface, the force may comprise an anisotropic force with a component normal to the surface at the point at which the force is applied. For example, referring to FIG. 1, a force may be applied in the direction of arrow 60. Arrow 62 illustrates the component of the force that is normal to active surface 52 of anode 50. In the case of a curved surface, for example, a concave surface or a convex surface, the force may comprise an anisotropic force with a component normal to a plane that is tangent to the curved surface at the point at which the force is applied. Referring to the cylindrical cell illustrated in FIG. 2, a force may be applied to an external surface of the cell in the direction of, for example, arrow 180. In some embodiments, the force may be applied from the interior of the cylindrical cell, for example, in the direction of arrow 182. In some embodiments, an anisotropic force with a component normal to the active surface of the anode is applied during at least one period of time during charge and/or discharge of the electrochemical cell. In some embodiments, the force may be applied continuously, over one period of time, or over multiple periods of time that may vary in duration and/or frequency. The anisotropic force may be applied, in some cases, at one or more pre-determined locations, optionally distributed over the active surface of the anode. In some embodiments, the anisotropic force is applied uniformly over the active surface of the anode.

An “anisotropic force” is given its ordinary meaning in the art and means a force that is not equal in all directions. A force equal in all directions is, for example, internal pressure of a fluid or material within the fluid or material, such as internal gas pressure of an object. Examples of forces not equal in all directions includes a force directed in a particular direction, such as the force on a table applied by an object on the table via gravity. Another example of an anisotropic force includes a force applied by a band arranged around a perimeter of an object. For example, a rubber band or turnbuckle can apply forces around a perimeter of an object around which it is wrapped. However, the band may not apply any direct force on any part of the exterior surface of the object not in contact with the band. In addition, when the band is expanded along a first axis to a greater extent than a second axis, the band can apply a larger force in the direction parallel to the first axis than the force applied parallel to the second axis.

A force with a “component normal” to a surface, for example an active surface of an anode, is given its ordinary meaning as would be understood by those of ordinary skill in the art and includes, for example, a force which at least in part exerts itself in a direction substantially perpendicular to the surface. For example, in the case of a horizontal table with an object resting on the table and affected only by gravity, the object exerts a force essentially completely normal to the surface of the table. If the object is also urged laterally across the horizontal table surface, then it exerts a force on the table which, while not completely perpendicular to the horizontal surface, includes a component normal to the table surface. Those of ordinary skill can understand other examples of these terms, especially as applied within the description of this document.

In some embodiments, the anisotropic force can be applied such that the magnitude of the force is substantially equal in all directions within a plane defining a cross-section of the electrochemical cell, but the magnitude of the forces in out-of-plane directions is substantially unequal to the magnitudes of the in-plane forces. For example, referring to FIG. 2, a cylindrical band may be positioned around the exterior of cell 100 such that forces (e.g., force 180) are applied to the cell oriented toward the cell's central axis (indicated by point 190 and extending into and out of the surface of the cross-sectional schematic diagram). In some embodiments, the magnitudes of the forces oriented toward the central axis of the cell are different (e.g., greater than) the magnitudes of the forces applied in out of plane directions (e.g., parallel to central axis 190). In one set of embodiments, cells of the invention are constructed and arranged to apply, during at least one period of time during charge and/or discharge of the cell, an anisotropic force with a component normal to the active surface of the anode. Those of ordinary skill in the art will understand the meaning of this. In such an arrangement, the cell may be formed as part of a container which applies such a force by virtue of a “load” applied during or after assembly of the cell, or applied during use of the cell as a result of expansion and/or contraction of one or more portions of the cell itself.

The magnitude of the applied force is, in some embodiments, large enough to enhance the performance of the electrochemical cell. The anode active surface and the anisotropic force may be, in some instances, together selected such that the anisotropic force affects surface morphology of the anode active surface to inhibit increase in anode active surface area through charge and discharge and wherein, in the absence of the anisotropic force but under otherwise essentially identical conditions, the anode active surface area is increased to a greater extent through charge and discharge cycles. In some instances, the cathode structure and/or material and the anisotropic force may be together selected such that the anisotropic force increases the conductivity within the cathode through charge and discharge compared to the conductivity in the absence of the anisotropic force but under otherwise essentially identical conditions. “Essentially identical conditions,” in this context, means conditions that are similar or identical other than the application and/or magnitude of the force. For example, otherwise identical conditions may mean a cell that is identical, but where it is not constructed (e.g., by brackets or other connections) to apply the anisotropic force on the subject cell.

Electrode materials or structures and anisotropic forces can be selected together, to achieve results described herein, by those of ordinary skill in the art. For example, where the electrode(s) is relatively soft, the component of the force normal to the anode active surface may be selected to be lower. Where the electrode(s) is harder, the component of the force normal to the active surface may be greater. Those of ordinary skill in the art can easily select electrode materials, alloys, mixtures, etc. with known or predictable properties, or readily test the hardness or softness of such surfaces, and readily select cell construction techniques and arrangements to provide appropriate forces to achieve what is described herein. Simple testing can be done, for example by arranging a series of active materials, each with a series of forces applied normal (or with a component normal) to the active surface, to determine the morphological effect of the force on the surface without cell cycling (for prediction of the selected combination during cell cycling) or with cell cycling with observation of a result relevant to the selection.

In some embodiments, an anisotropic force with a component normal to the active surface of the anode is applied, during at least one period of time during charge and/or discharge of the cell, to an extent effective to inhibit an increase in surface area of the anode active surface relative to an increase in surface area absent the anisotropic force. The component of the anisotropic force normal to the anode active surface may, for example, define a pressure of at least about 4.9, at least about 9.8, at least about 24.5, at least about 49, at least about 73.5, at least about 98, at least about 117.6, at least about 147, or at least about 196 Newtons per square centimeter of the anode active surface. In some embodiments, the component of the anisotropic force normal to the anode active surface may, for example, define a pressure of less than about 196, less than about 147, less than about 117.6, less than about 98, less than about 73.5, less than about 49, less than about 24.5, or less than about 9.8 Newtons per square centimeter of the anode active surface. In some cases, the component of the anisotropic force normal to the anode active surface may define a pressure of between about 4.9 and about 196 Newtons per square centimeter of the anode active surface, between about 49 and about 147 Newtons per square centimeter of the anode active surface, between about 78.4 and about 117.6 Newtons per square centimeter of the anode active surface, or between about 88.2 and about 107.8 Newtons per square centimeter of the anode active surface . While forces and pressures are generally described herein in units of Newtons and Newtons per unit area, respectively, forces and pressures can also be expressed in units of kilograms-force and kilograms-force per unit area, respectively. One or ordinary skill in the art will be familiar with kilogram-force-based units, and will understand that 1 kilogram-force is equivalent to about 9.8 Newtons.

In some cases, one or more forces applied to the cell have a component that is not normal to an active surface of an anode. For example, in FIG. 1, force 60 is not normal to anode active surface 52, and force 60 includes component 64, which is substantially parallel to anode active surface 52. In addition, a force 66, which is substantially parallel to anode active surface 52, could be applied to the cell in some cases. In one set of embodiments, the sum of the components of all applied anisotropic forces in a direction normal to the anode active surface is larger than any sum of components in a direction that is non-normal to the anode active surface. In some embodiments, the sum of the components of all applied anisotropic forces in a direction normal to the anode active surface is at least about 5%, at least about 10%, at least about 20%, at least about 35%, at least about 50%, at least about 75%, at least about 90%, at least about 95%, at least about 99%, or at least about 99.9% larger than any sum of components in a direction that is parallel to the anode active surface.

In some embodiments, the cathode and anode have yield stresses, wherein the effective yield stress of one of the cathode and anode is greater than the yield stress of the other, such that an anisotropic force applied normal to the surface of one of the active surface of the anode and the active surface of the cathode causes the surface morphology of one of the cathode and the anode to be affected. In some embodiments, the component of the anisotropic force normal to the anode active surface is between about 20% and about 200% of the yield stress of the anode material, between about 50% and about 120% of the yield stress of the anode material, or between about 80% and about 100% of the yield stress of the anode material.

The anisotropic force described herein may be applied using any method known in the art. In some embodiments, the force may be applied using compression springs. For example, referring to FIG. 1, electrochemical cell 10 may be situated in an optional enclosed containment structure 56 with one or more compression springs situated between surface 54 and the adjacent wall of the containment structure to produce a force with a component in the direction of arrow 62. In some embodiments, the force may be applied by situating one or more compression springs outside the containment structure such that the spring is located between an outside surface 58 of the containment structure and another surface (e.g., a tabletop, the inside surface of another containment structure, an adjacent cell, etc.). Forces may be applied using other elements (either inside or outside a containment structure) including, but not limited to Belleville washers, machine screws, pneumatic devices, and/or weights, among others. For example, in one set of embodiments, one or more cells (e.g., a stack of cells) are arranged between two plates (e.g., metal plates). A device (e.g., a machine screw, a spring, etc.) may be used to apply pressure to the ends of the cell or stack via the plates. In the case of a machine screw, for example, the cells may be compressed between the plates upon rotating the screw. As another example, in some embodiments, one or more wedges may be displaced between a surface of the cell (or the containment structure surrounding the cell) and a fixed surface (e.g., a tabletop, the inside surface of another containment structure, an adjacent cell, etc.). The anisotropic force may be applied by driving the wedge between the cell and the adjacent fixed surface through the application of force on the wedge (e.g., by turning a machine screw).

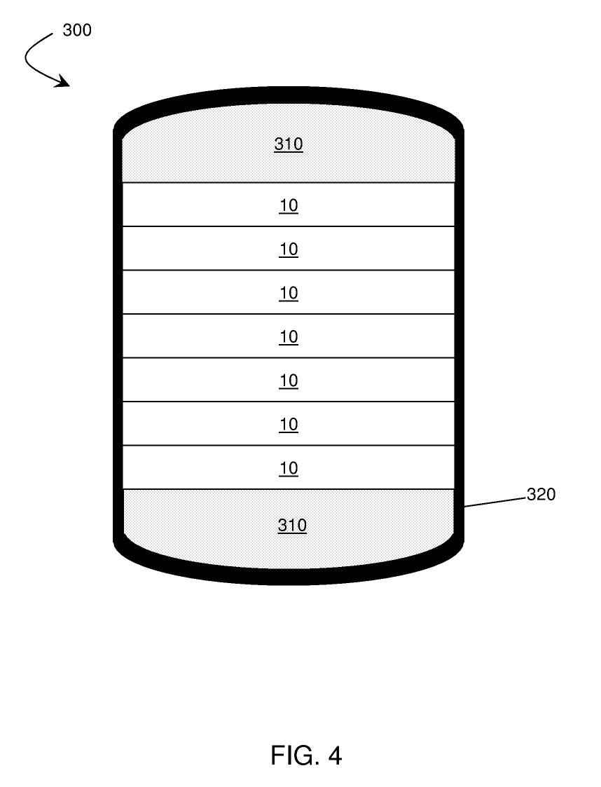

In some embodiments, the anisotropic force may be applied by surrounding the cell or stack of cells with a band (e.g., a rubber band, a turnbuckle band, etc.). An example of such an arrangement is illustrated in FIG. 4. In this set of embodiments, a band 320 surrounds a stack of cells 10. Optionally, in some embodiments, caps 310 may be placed between the ends of the stack and the band. The caps shown in FIG. 4 include rounded ends, which may, for example, be used to reduce separation of the band from the stack at corners and edges and enhance the uniformity of the distribution of force. The caps can comprise any material including, for example, metal, plastic, etc. In some cases, the band comprises a turnbuckle band (e.g., a Kevlar turnbuckle band), and force is applied by tightening the band and securing the turnbuckle. In some instances, the band is a continuous elastic band. In some cases, after the elastic band is stretched and positioned around the cell(s), a force may be applied via the elastic constriction of the band. In cases where the band is an elastic band, the band may comprise any material with an amount of elasticity necessary to produce the desired force. In some cases, the elastic band may comprise a polymeric material. Materials that may be used in such an application include, for example, Desmopan 392 (a polyester urethane, made by Bayer MaterialScience, Leverkusen, Germany).

In some cases, the cells described herein may change size (e.g., swell) during charge and discharge. When selecting the method of applying the anisotropic force, it may be desirable, in some embodiments, to select methods that produce a relatively constant force as the cell changes shape and/or size during charge and discharge. In some instances, this selection may be analogous to selecting a system with a low effective spring constant (e.g., a “soft” spring). For example, when using a compression spring to apply the anisotropic force, a spring with a relatively low spring constant may produce an anisotropic force that is more constant during cell cycling than the force produced by a spring with a relatively high spring constant. In cases where elastic bands are used, a band with a relatively high elasticity may produce an anisotropic force that is more constant during cell cycling than the force produced by a band with a relatively low elasticity. In some embodiments in which force is applied using a machine screw, the use of soft screws (e.g., brass, polymer, etc.) may be advantageous. In some applications, for example, a machine screw may be selected to cover a desired range of compression, but the screw itself may be soft.

In some embodiments, the electrochemical cells of the present invention are placed in containment structures, and at least a portion of an anisotropic force with a component normal to the active surface of the anode is produced due to the expansion of the electrochemical cell relative to the containment structure. In some cases, the containment structure is sufficiently rigid such that it does not deform during the expansion of the electrochemical cell, resulting in a force applied on the cell. The electrochemical cell may swell as the result of a variety of phenomena. For example, in some cases, the electrochemical cell may undergo thermal expansion. In some embodiments, the electrochemical cell may swell due to charge and/or discharge of the cell. For example, in some cases, a partially discharged cell may be placed in a containment structure. Upon charging the partially discharged cell, the cell may swell. This expansion may be limited by the dimensions of the containment structure, resulting in the application of an anisotropic force.

In some cases, the cell may swell due to the adsorption of a liquid into porous components of the electrochemical cell. For example, in some embodiments, a dry porous electrochemical cell may be placed within a containment structure. The dry porous electrochemical cell may then be soaked (e.g., with a liquid electrolyte). In some cases, the properties of the electrolyte (e.g., surface tension) and the electrochemical cell (e.g., size of the porous cavities) may be selected such that, when the electrochemical cell is wetted by the electrolyte, a desirable level of capillary pressure is generated. Once wetted, the electrode stack will swell, thus generating an anisotropic force. At equilibrium, the anisotropic force exerted by the containment structure on the electrochemical cell will be equal to the force resulting from the capillary pressure.

Containment structures described herein may comprise a variety of shapes including, but not limited to, cylinders, prisms (e.g., triangular prisms, rectangular prisms, etc.), cubes, or any other shape. In some embodiments, the shape of the containment structure is chosen such that the walls of the containment structure are parallel to the outer surfaces of the electrochemical cell. For example, in some cases, the containment structure may comprise a cylinder, which can be used, for example, to surround and contain a cylindrical electrochemical cell. In other instances, the containment structure may comprise a prism surrounding a similarly shaped prismatic electrochemical cell.

In some embodiments, the invention relates to the discovery that the application of a force as described herein may allow for the use of smaller amounts of anode active material (e.g., lithium) and/or electrolyte within an electrochemical cell, relative to the amounts used in essentially identical cells in which the force is not applied. In cells lacking the applied force described herein, anode active material (e.g., lithium metal) may be, in some cases, redeposited unevenly on an anode during charge-discharge cycles of the cell, forming a rough surface. In some cases, this may lead to an increase in the rates of one or more undesired reactions involving the anode metal. These undesired reactions may, after a number of charge-discharge cycles, stabilize and/or begin to self-inhibit such that substantially no additional anode active material becomes depleted and the cell may function with the remaining active materials. For cells lacking the applied force as described herein, this “stabilization” is often reached only after a substantial amount of anode active material has been consumed and cell performance has deteriorated. Therefore, in some cases where forces as described herein have not been applied, a relatively large amount of anode active material and/or electrolyte has often been incorporated within cells to accommodate for loss of material during consumption of active materials, in order to preserve cell performance.

Accordingly, the application of force as described herein may reduce and/or prevent depletion of active materials such that the inclusion of large amounts of anode active material and/or electrolyte within the electrochemical cell may not be necessary. For example, the force may be applied to a cell prior to use of the cell, or in an early stage in the lifetime of the cell (e.g., less than five charge-discharge cycles), such that little or substantially no depletion of active material may occur upon charging or discharging of the cell. By reducing and/or eliminating the need to accommodate for active material loss during charge-discharge of the cell, relatively small amounts of anode active material may be used to fabricate cells and devices as described herein.

In some embodiments, the invention relates to devices comprising an electrochemical cell having been charged and discharged less than five times in its lifetime, wherein the cell comprises an anode, a cathode, and an electrolyte, wherein the anode comprises no more than five times the amount of anode active material which can be ionized during one full discharge cycle of the cell. In some cases, the anode comprises no more than four, three, two, or 1.5 times the amount of lithium which can be ionized during one full discharge cycle of the cell.

In some cases, the present invention relates to devices comprising an electrochemical cell, wherein the cell comprises an anode active material, a cathode active material, and an electrolyte, wherein the ratio of the amount of anode active material in the anode to the amount of cathode active material in the cathode is less than about 5:1, less than about 3:1, less than about 2:1, or less than about 1.5:1 on a molar basis. For example, a cell may comprise lithium as an anode active material and sulfur as an cathode active material, wherein the molar ratio Li:S is less than about 5:1. In some cases, the molar ratio of lithium to sulfur, Li:S, is less than about 3:1, less than about 2:1, or less than about 1.5:1. In some embodiments, the ratio of anode active material (e.g., lithium) to cathode active material by weight may be less than about 2:1, less than about 1.5:1, less than about 1.25:1, or less than about 1.1:1. For example, a cell may comprise lithium as the anode active material and sulfur as the cathode active material, wherein the ratio Li:S by weight is less than about 2:1, less than about 1.5:1, less than about 1.25:1, or less than about 1.1:1.

The use of smaller amounts of anode active material and/or electrolyte material may advantageously allow for electrochemical cells, or portions thereof, having decreased thickness. In some embodiments, the anode layer and the electrolyte layer together have a maximum thickness of 500 microns. In some cases, the anode layer and the electrolyte layer together have a maximum thickness of 400 microns, 300 microns, 200 microns, or, in some cases, 100 microns.

In some embodiments, the application of force, as described herein, may result in improved capacity after repeated cycling of the electrochemical cell. For example, in some embodiments, after alternatively discharging and charging the cell three times, the cell exhibits at least about 50%, at least about 80%, at least about 90%, or at least about 95% of the cell's initial capacity at the end of the third cycle. In some cases, after alternatively discharging and charging the cell ten times, the cell exhibits at least about 50%, at least about 80%, at least about 90%, or at least about 95% of the cell's initial capacity at the end of the tenth cycle. In still further cases, after alternatively discharging and charging the cell twenty-five times, the cell exhibits at least about 50%, at least about 80%, at least about 90%, or at least about 95% of the cell's initial capacity at the end of the twenty-fifth cycle.

As mentioned above, the cathode may include a variety of electroactive materials. Suitable electroactive materials for use as cathode active materials in the cathode of the electrochemical cells of the invention include, but are not limited to, electroactive transition metal chalcogenides, electroactive conductive polymers, sulfur, carbon and/or combinations thereof. As used herein, the term “chalcogenides” pertains to compounds that contain one or more of the elements of oxygen, sulfur, and selenium. Examples of suitable transition metal chalcogenides include, but are not limited to, the electroactive oxides, sulfides, and selenides of transition metals selected from the group consisting of Mn, V, Cr, Ti, Fe, Co, Ni, Cu, Y, Zr, Nb, Mo, Ru, Rh, Pd, Ag, Hf, Ta, W, Re, Os, and Ir. In one embodiment, the transition metal chalcogenide is selected from the group consisting of the electroactive oxides of nickel, manganese, cobalt, and vanadium, and the electroactive sulfides of iron. In one embodiment, a cathode includes one or more of the following materials: manganese dioxide, iodine, silver chromate, silver oxide and vanadium pentoxide, copper oxide, copper oxyphosphate, lead sulfide, copper sulfide, iron sulfide, lead bismuthate, bismuth trioxide, cobalt dioxide, copper chloride, manganese dioxide, and carbon. In another embodiment, the cathode active layer comprises an electroactive conductive polymer. Examples of suitable electroactive conductive polymers include, but are not limited to, electroactive and electronically conductive polymers selected from the group consisting of polypyrroles, polyanilines, polyphenylenes, polythiophenes, and polyacetylenes. Examples of conductive polymers include polypyrroles, polyanilines, and polyacetylenes.

In one embodiment, an electroactive sulfur-containing material of a cathode active layer comprises greater than 50% by weight of sulfur. In another embodiment, the electroactive sulfur-containing material comprises greater than 75% by weight of sulfur. In yet another embodiment, the electroactive sulfur-containing material comprises greater than 90% by weight of sulfur.

The cathode active layers of the present invention may comprise from about 20 to 100% by weight of electroactive cathode materials (e.g., as measured after an appropriate amount of solvent has been removed from the cathode active layer and/or after the layer has been appropriately cured). In one embodiment, the amount of electroactive sulfur-containing material in the cathode active layer is in the range of 5-30% by weight of the cathode active layer. In another embodiment, the amount of electroactive sulfur-containing material in the cathode active layer is in the range of 20% to 90% by weight of the cathode active layer.

Non-limiting examples of suitable liquid media (e.g., solvents) for the preparation of cathodes (as well as other components of cells described herein) include aqueous liquids, non-aqueous liquids, and mixtures thereof. In some embodiments, liquids such as, for example, water, methanol, ethanol, isopropanol, propanol, butanol, tetrahydrofuran, dimethoxyethane, acetone, toluene, xylene, acetonitrile, cyclohexane, and mixtures thereof can be used. Of course, other suitable solvents can also be used as needed.

Positive electrode layers may be prepared by methods known in the art. For example, one suitable method comprises the steps of: (a) dispersing or suspending in a liquid medium the electroactive sulfur-containing material, as described herein; (b) optionally adding to the mixture of step (a) a conductive filler and/or binder; (c) mixing the composition resulting from step (b) to disperse the electroactive sulfur-containing material; (d) casting the composition resulting from step (c) onto a suitable substrate; and (e) removing some or all of the liquid from the composition resulting from step (d) to provide the cathode active layer.

The anode may also include a variety of electroactive materials. Suitable electroactive materials for use as anode active materials in the anode of the electrochemical cells described herein include, but are not limited to, lithium metal such as lithium foil and lithium deposited onto a conductive substrate, and lithium alloys (e.g., lithium-aluminum alloys and lithium-tin alloys). While these are preferred negative electrode materials, the current collectors may also be used with other cell chemistries. In some embodiments, the anode may comprise one or more binder materials (e.g., polymers, etc.).

Methods for depositing a negative electrode material (e.g., an alkali metal anode such as lithium) onto a substrate may include methods such as thermal evaporation, sputtering, jet vapor deposition, and laser ablation. Alternatively, where the anode comprises a lithium foil, or a lithium foil and a substrate, these can be laminated together by a lamination process as known in the art to form an anode.

In one embodiment, an electroactive lithium-containing material of an anode active layer comprises greater than 50% by weight of lithium. In another embodiment, the electroactive lithium-containing material of an anode active layer comprises greater than 75% by weight of lithium. In yet another embodiment, the electroactive lithium-containing material of an anode active layer comprises greater than 90% by weight of lithium.

Positive and/or negative electrodes may optionally include one or more layers that interact favorably with a suitable electrolyte, such as those described in U.S. patent application Ser. No. 12/312,764, filed May 26, 2009 and entitled “Separation of Electrolytes,” by Mikhaylik et al., which is incorporated herein by reference in its entirety.

The electrolytes used in electrochemical or battery cells can function as a medium for the storage and transport of ions, and in the special case of solid electrolytes and gel electrolytes, these materials may additionally function as a separator between the anode and the cathode. Any liquid, solid, or gel material capable of storing and transporting ions may be used, so long as the material facilitates the transport of ions (e.g., lithium ions) between the anode and the cathode. The electrolyte is electronically non-conductive to prevent short circuiting between the anode and the cathode. In some embodiments, the electrolyte may comprise a non-solid electrolyte.

In some embodiments, the electrolyte comprises a fluid that can be added at any point in the fabrication process. In some cases, the electrochemical cell may be fabricated by providing a cathode and an anode, applying an anisotropic force component normal to the active surface of the anode, and subsequently adding the fluid electrolyte such that the electrolyte is in electrochemical communication with the cathode and the anode. In other cases, the fluid electrolyte may be added to the electrochemical cell prior to or simultaneously with the application of the anisotropic force component, after which the electrolyte is in electrochemical communication with the cathode and the anode.

The electrolyte can comprise one or more ionic electrolyte salts to provide ionic conductivity and one or more liquid electrolyte solvents, gel polymer materials, or polymer materials. Suitable non-aqueous electrolytes may include organic electrolytes comprising one or more materials selected from the group consisting of liquid electrolytes, gel polymer electrolytes, and solid polymer electrolytes. Examples of non-aqueous electrolytes for lithium batteries are described by Dorniney in Lithium Batteries, New Materials, Developments and Perspectives, Chapter 4, pp. 137-165, Elsevier, Amsterdam (1994). Examples of gel polymer electrolytes and solid polymer electrolytes are described by Alamgir et al. in Lithium Batteries, New Materials, Developments and Perspectives, Chapter 3, pp. 93-136, Elsevier, Amsterdam (1994). Heterogeneous electrolyte compositions that can be used in batteries described herein are described in U.S. patent application Ser. No. 12/312,764, filed May 26, 2009 and entitled “Separation of Electrolytes,” by Mikhaylik et al. Examples of useful non-aqueous liquid electrolyte solvents include, but are not limited to, non-aqueous organic solvents, such as, for example, N-methyl acetamide, acetonitrile, acetals, ketals, esters, carbonates, sulfones, sulfites, sulfolanes, aliphatic ethers, cyclic ethers, glymes, polyethers, phosphate esters, siloxanes, dioxolanes, N-alkylpyrrolidones, substituted forms of the foregoing, and blends thereof. Fluorinated derivatives of the foregoing are also useful as liquid electrolyte solvents.

In some cases, aqueous solvents can be used as electrolytes for lithium cells. Aqueous solvents can include water, which can contain other components such as ionic salts. As noted above, in some embodiments, the electrolyte can include species such as lithium hydroxide, or other species rendering the electrolyte basic, so as to reduce the concentration of hydrogen ions in the electrolyte.

Liquid electrolyte solvents can also be useful as plasticizers for gel polymer electrolytes, i.e., electrolytes comprising one or more polymers forming a semi-solid network. Examples of useful gel polymer electrolytes include, but are not limited to, those comprising one or more polymers selected from the group consisting of polyethylene oxides, polypropylene oxides, polyacrylonitriles, polysiloxanes, polyimides, polyphosphazenes, polyethers, sulfonated polyimides, perfluorinated membranes (NAFION resins), polydivinyl polyethylene glycols, polyethylene glycol diacrylates, polyethylene glycol dimethacrylates, derivatives of the foregoing, copolymers of the foregoing, crosslinked and network structures of the foregoing, and blends of the foregoing, and optionally, one or more plasticizers. In some embodiments, a gel polymer electrolyte comprises between 10-20%, 20-40%, between 60-70%, between 70-80%, between 80-90%, or between 90-95% of a heterogeneous electrolyte by volume.

In some embodiments, one or more solid polymers can be used to form an electrolyte. Examples of useful solid polymer electrolytes include, but are not limited to, those comprising one or more polymers selected from the group consisting of polyethers, polyethylene oxides, polypropylene oxides, polyimides, polyphosphazenes, polyacrylonitriles, polysiloxanes, derivatives of the foregoing, copolymers of the foregoing, crosslinked and network structures of the foregoing, and blends of the foregoing.

In addition to electrolyte solvents, gelling agents, and polymers as known in the art for forming electrolytes, the electrolyte may further comprise one or more ionic electrolyte salts, also as known in the art, to increase the ionic conductivity.

Examples of ionic electrolyte salts for use in the electrolytes of the present invention include, but are not limited to, LiSCN, LiBr, LiI, LiClO₄, LiAsF₆, LiSO₃CF₃, LiSO₃CH₃, LiBF₄, LiB(Ph)₄, LiPF₆, LiC(SO₂CF₃)₃, and LiN(SO₂CF₃)₂. Other electrolyte salts that may be useful include lithium polysulfides (Li₂Sₓ), and lithium salts of organic ionic polysulfides (LiSₓR)ₙ, where x is an integer from 1 to 20, n is an integer from 1 to 3, and R is an organic group, and those disclosed in U.S. Pat. No. 5,538,812 to Lee et al.

In some embodiments, electrochemical cells may further comprise a separator interposed between the cathode and anode. The separator may be a solid non-conductive or insulative material which separates or insulates the anode and the cathode from each other preventing short circuiting, and which permits the transport of ions between the anode and the cathode. In some embodiments, the porous separator may be permeable to the electrolyte.

The pores of the separator may be partially or substantially filled with electrolyte. Separators may be supplied as porous free standing films which are interleaved with the anodes and the cathodes during the fabrication of cells. Alternatively, the porous separator layer may be applied directly to the surface of one of the electrodes, for example, as described in PCT Publication No. WO 99/33125 to Carlson et al. and in U.S. Pat. No. 5,194,341 to Bagley et al.

A variety of separator materials are known in the art. Examples of suitable solid porous separator materials include, but are not limited to, polyolefins, such as, for example, polyethylenes (e.g., SETELA™ made by Tonen Chemical Corp) and polypropylenes, glass fiber filter papers, and ceramic materials. For example, in some embodiments, the separator comprises a microporous polyethylene film. Further examples of separators and separator materials suitable for use in this invention are those comprising a microporous xerogel layer, for example, a microporous pseudo-boehmite layer, which may be provided either as a free standing film or by a direct coating application on one of the electrodes, as described in U.S. Pat. Nos. 6,153,337 and 6,306,545 by Carlson et al. of the common assignee. Solid electrolytes and gel electrolytes may also function as a separator in addition to their electrolyte function.

The following documents are incorporated herein by reference in their entireties for all purposes: U.S. Pat. No. 7,247,408, filed May 23, 2001, entitled “Lithium Anodes for Electrochemical Cells”; U.S. Pat. No. 5,648,187, filed Mar. 19, 1996, entitled “Stabilized Anode for Lithium-Polymer Batteries”; U.S. Pat. No. 5,961,672, filed Jul. 7, 1997, entitled “Stabilized Anode for Lithium-Polymer Batteries”; U.S. Pat. No. 5,919,587, filed May 21, 1997, entitled “Novel Composite Cathodes, Electrochemical Cells Comprising Novel Composite Cathodes, and Processes for Fabricating Same”; U.S. patent application Ser. No. 11/400,781, filed Apr. 6, 2006, entitled “Rechargeable Lithium/Water, Lithium/Air Batteries”; International Patent Apl. Serial No.: PCT/US2008/009158, filed Jul. 29, 2008, entitled “Swelling Inhibition in Lithium Batteries”; U.S. patent application Ser. No. 12/312,764, filed May 26, 2009, entitled “Separation of Electrolytes”; International Patent Apl. Serial No.: PCT/US2008/012042, filed Oct. 23, 2008, entitled “Primer for Battery Electrode”; U.S. patent application Ser. No. 12/069,335, filed Feb. 8, 2008, entitled “Protective Circuit for Energy-Storage Device”; U.S. patent application Ser. No. 11/400,025, filed Apr. 6, 2006, entitled “Electrode Protection in both Aqueous and Non-Aqueous Electrochemical Cells, including Rechargeable Lithium Batteries”; U.S. patent application Ser. No. 11/821,576, filed Jun. 22, 2007, entitled “Lithium Alloy/Sulfur Batteries”; patent application Ser. No. 11/111,262, filed Apr. 20, 2005, entitled “Lithium Sulfur Rechargeable Battery Fuel Gauge Systems and Methods”; U.S. patent application Ser. No. 11/728,197, filed Mar. 23, 2007, entitled “Co-Flash Evaporation of Polymerizable Monomers and Non-Polymerizable Carrier Solvent/Salt Mixtures/Solutions”; International Patent Apl. Serial No.: PCT/US2008/010894, filed Sep. 19, 2008, entitled “Electrolyte Additives for Lithium Batteries and Related Methods”; International Patent Apl. Serial No.: PCT/US2009/000090, filed Jan. 8, 2009, entitled “Porous Electrodes and Associated Methods”; U.S. patent application Ser. No. 12/535,328, filed Aug. 4, 2009, published on Feb. 11, 2010 as U.S. Patent Publication No. 2010/0035128, entitled “Application of Force In Electrochemical Cells”; Provisional Patent Apl. Ser. No. 61/161,529, filed Mar. 19, 2009, entitled “Cathode for Lithium Battery”; U.S. patent application Ser. No. 12,471,095, filed May 22, 2009, entitled “Hermetic Sample Holder and Method for Performing Microanalysis Under Controlled Atmosphere Environment”; and Provisional Patent Apl. Ser. No. 61/236,322, filed Aug. 24, 2009, entitled “Release System for Electrochemical Cells.”

The following examples are intended to illustrate certain embodiments of the present invention, but do not exemplify the full scope of the invention.

### Example 1

This example describes the fabrication and testing of cathodes, according to one set of embodiments. Slurries were made by dissolving 47.5% sulfur, 47.5% XE-2 carbon, and 5% PVOH binder in solvents. The slurries were coated on aluminum foil primed with a conductive carbon layer and dried to make the cathodes. The active material loading in the cathodes was about 1.41 mg/cm². Pouch cells were made with the above-mentioned cathodes, separators, and lithium anodes. The active areas of the cathodes in the cells were about 16.57 cm². The electrolytes contained primarily dioxalane and di-methoxy ethane, as well as limited amounts of lithium bis(trifluoromethyl sulfonyl) imide, LiNO₃, Guanidine nitrate and Pyridine nitrate. The discharge and charge currents used for cycling were 0.4 mA/cm² and 0.236 mA/cm², respectively. The amount of electrolyte used in the cells was 0.2 mL. One set of the cells undergoing the above cycling tests was kept under a pressure of 98 Newtons per square centimeter by compressing the cells between two parallel metallic plates, whereas the other set was cycled without any compression. The resulting cathode properties are outlined in Table 1, and the cell performance characteristics are outlined in Table 2. The charge efficiency of the 10th cycle is calculated as:

$$Charge {Efficiency}_{10 th Cycle} ( \% ) = \frac{Discharge {Capacity}_{{11}^{th} cycle}}{Charge {Capacity}_{{10}^{th} cycle}} \times 100 \qquad [ 1 ]$$

TABLE 1
Example 1 Cathode Properties

Applied Pressure

| | | 98 N/cm² |
|---|---|---|
| Cathode Parameter | 0 N/cm² | (=10 kg_{f}/cm²) |
| Thickness (microns) | 84 | 51 |
| Cathode porosity (%) | 82 | 70 |
| Void volume/g or S₈ (mLl/g) | 4.9 | 2.6 |

TABLE 2
Example 1 Cell Performance Characteristics

| | Applied Pressure | |
|---|---|---|
| | | 98 N/cm² |
| Cathode Parameter | 0 N/cm² | (=10 kg_{f}/cm²) |
| Discharge Capacity (1^{st} cycle) | 1301 mAh/g of S₈ | 1466 mAh/g of S₈ |
| Discharge Capacity (10^{th} cycle) | 1327 mAh/g of S₈ | 1228 mAh/g of S₈ |
| Discharge Capacity (50^{th} cycle) | 1327 mAh/g of S₈ | 1228 mAh/g of S₈ |
| Charge Efficiency (10^{th} cycle) | 99.1% | 96% |
| Charge Efficiency (50^{th} cycle) | 99% | 94% |
| No. of cycles to stabilize capacity | 10 | 0 |

### Example 2

This example describes the fabrication and testing of another set of cathodes, according to one set of embodiments. Slurries were made by dissolving 47.5% sulfur, 47.5% XE-2 carbon, and 5% PVOH binder in solvents. The slurries were coated on aluminum foil primed with a conductive carbon layer and dried to make the cathode. The active material loading in the cathodes was about 1.13 mg/cm². Pouch cells were made with the above-mentioned cathodes, separators and lithium anodes. The active areas of the cathodes were about 16.57 cm². The electrolytes contained primarily dioxalane and di-methoxy ethane, with limited amounts of lithium bis(trifluoromethyl sulfonyl) imide, LiNO₃, Guanidine nitrate and Pyridine nitrate. The discharge and charge currents used for cycling were 0.4 mA/cm² and 0.236 mA/cm², respectively. The amount of electrolyte used in the cells was 0.2 mL. One set of the cells undergoing the above cycling tests was kept under a pressure of 98 Newtons per square centimeter by compressing the cells between two parallel metallic plates, whereas the another set was cycled without any compression. Table 3 outlines the cathode properties, and Table 4 outlines the cathode performance characteristics.

TABLE 3
Example 2 Cathode Properties

Applied Pressure

| | | 98 N/cm² |
|---|---|---|
| Cathode Parameter | 0 N/cm² | (=10 kg_{f}/cm²) |
| Thickness (microns) | 62 | 36 |
| Cathode porosity (%) | 80 | 67 |
| Void volume/g or S₈ (ml/g) | 4.37 | 2.16 |

TABLE 4
Example 2 Cell Performance Characteristics

| | Applied Pressure | |
|---|---|---|
| | | 98 N/cm² |
| Cathode Parameter | 0 N/cm² | (=10 kg_{f}/cm²) |
| Discharge Capacity (1^{st} cycle) | 1370 mAh/g of S₈ | 1530 mAh/g of S₈ |
| Discharge Capacity (10^{th} cycle) | 1330 mAh/g of S₈ | 1220 mAh/g of S₈ |
| Discharge Capacity (50^{th} cycle) | 1219 mAh/g of S₈ | 903 mAh/g of S₈ |
| Charge Efficiency (10^{th} cycle) | 98.7% | 100% |
| Charge Efficiency (50^{th} cycle) | 99.7% | 100% |
| No. of cycles to stabilize capacity | 8 | 0 |

### Example 3

Another set of cathodes was fabricated and tested as follows. Slurries were made by dissolving 47.5% sulfur, 47.5% XE-2 carbon, and 5% PVOH binder in solvents. The slurries were coated on aluminum foil primed with a conductive carbon layer and dried to make the cathodes. The active material loading in the cathodes was 1.13 mg/cm². Pouch cells were made with the above-mentioned cathodes, separators and lithium anodes. The active area of the cathodes was about 16.57 cm². The electrolytes contained primarily dioxalane and di-methoxy ethane, with limited amounts of lithium bis(trifluoromethyl sulfonyl) imide, LiNO₃, Guanidine nitrate, and Pyridine nitrate. The amount of electrolyte used in the cells was 0.15 mL. One of the two sets of the cells undergoing the cycling tests was kept under a pressure of 98 Newtons per square centimeter by compressing the cells between two parallel metallic plates. The other set was cycled without any compression. The discharge and charge currents used for cycling were 0.4 mA/cm² and 0.236 mA/cm², respectively. The charge current was increased to 1.21 mA/cm² from the 63rd cycle for the cell cycling under pressure and from the 67th cycle for the cell cycling without any applied pressure. Table 5 outlines the resulting cathode properties.

TABLE 5
Example 3 Cathode Properties

Applied Pressure

| | | 98 N/cm² |
|---|---|---|
| Cathode Parameter | 0 N/cm² | (=10 kg_{f}/cm²) |
| Thickness (microns) | 62 | 36 |
| Cathode porosity (%) | 80 | 67 |
| Void volume/g or S₈ (ml/g) | 4.37 | 2.16 |

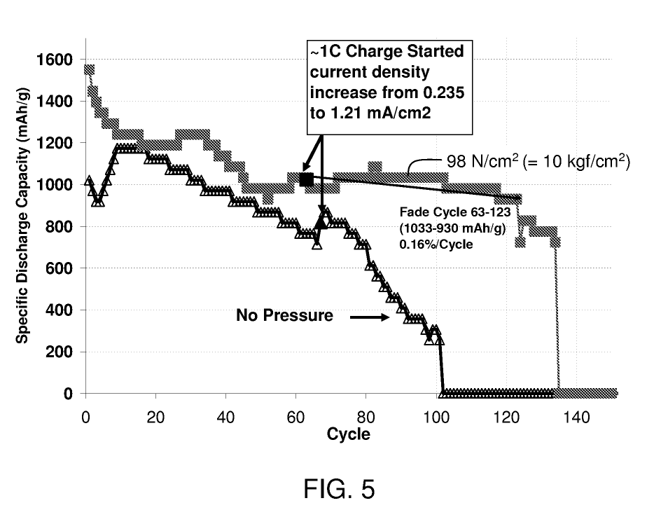

FIG. 5 includes a plot of the specific discharge capacity as a function of the number of charge/discharge cycles for a cell cycled under a force defining a pressure of 98 Newtons per square centimeter and a cell cycled without pressure. As shown in FIG. 5, the capacity fade under high charge current (from cycles 63 to 123) was very low (0.16%/cycle) for the cell cycled under 98 Newtons per square centimeter of pressure. The cell that was cycled without any applied pressure showed a drastic increase in the rate of capacity fade when the charge rate was increased from the 67th cycle onwards; the capacity fade rate was 2.03%/cycle from the 67th cycle to the 101st cycle.

### Example 4

This example describes the fabrication and testing of yet another set of cathodes, according to one set of embodiments. Slurries were made by dissolving 47.5% sulfur, 47.5% XE-2 carbon, and 5% PVOH binder in solvents. The slurries were coated on aluminum foil primed with conductive carbon layer and dried to make the cathode. The ACM loading in the cathodes was about 1.41 mg/cm². Pouch cells were made with the above-mentioned cathodes, separators and lithium anodes. The active areas of the cathodes in the cells were about 16.57 cm². The electrolytes contained primarily dioxalane and di-methoxy ethane, with limited amounts of lithium bis(trifluoromethyl sulfonyl) imide, LiNO₃, Guanidine nitrate, and Pyridine nitrate. The amount of electrolyte used in the cells was 0.2 ml. One set of the cells was kept under a pressure of 98 Newtons per square centimeter by compressing them between two parallel metallic plates. Another set was cycled without any compression. The discharge and charge currents used for cycling were 0.4 mA/cm² and 0.236 mA/cm², respectively. Table 6A includes the resulting cathode properties.

TABLE 6A
Example 4 Cathode Properties

Applied Pressure

| | | 98 N/cm² |
|---|---|---|
| Cathode Parameter | 0 N/cm² | (=10 kg_{f}/cm²) |
| Thickness (microns) | 84 | 51 |
| Cathode porosity (%) | 82 | 70 |
| Void volume/g or S₈ (ml/g) | 4.9 | 2.6 |

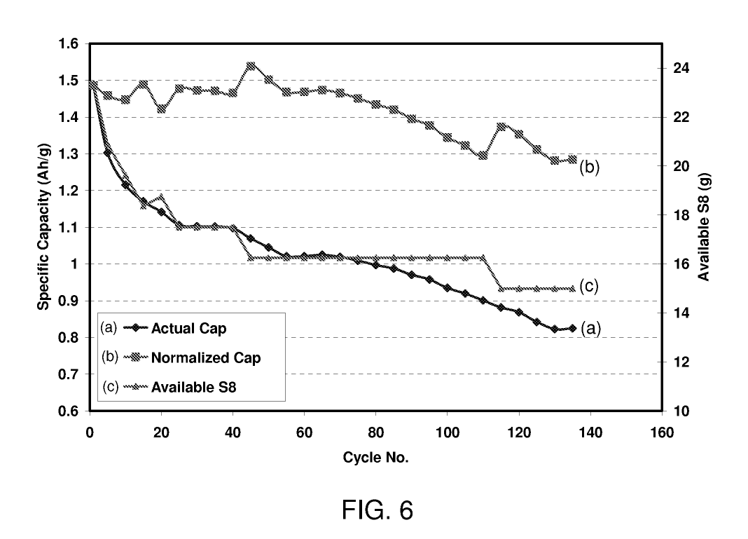

FIG. 6 includes a plot of specific capacity (actual and normalized) and available sulfur as a function of the number of charge/discharge cycles for a cell cycled under 98 Newtons per square centimeter of pressure. Curve (a) is the specific capacity (mA/g of initial amount of S₈) of the cell cycled under 98 Newtons per square centimeter of pressure. By analyzing the discharge profiles of individual cycles, the amount of sulfur available in the region of the cell that is enclosed by the anode and cathode was estimated (as described below) and is presented as Curve (c) on FIG. 6. Using the values of the available sulfur amounts thus estimated, the normalized specific capacity of a cell was calculated as a function of cycle number (Curve (b) in FIG. 6). The normalized specific capacity of the cell cycling under 98 Newtons per square centimeter of pressure showed very little decrease even after 135 cycles. This indicates that the application of pressure on the above-described cathode enabled the cell to better retain its ability to utilize the available sulfur even after 135 cycles. Table 6B provides the normalized specific capacity (Ah/g of available S₈) after various cycles. It can be seen here that even at the end of 135 cycles, it is possible to utilize 76.84% of the available sulfur.

TABLE 6B
Example 4 Cell Performance Characteristics

| | Normalized Specific Capacity | Normalized S₈ |
|---|---|---|
| Cycle Number | (Ah/g of available S₈) | Utilization (%) |
| 1 | 1.485 | 88.91 |
| 5 | 1.458 | 87.28 |
| 100 | 1.344 | 80.43 |
| 135 | 1.284 | 76.84 |

### Estimation of Available Amount of Sulfur:

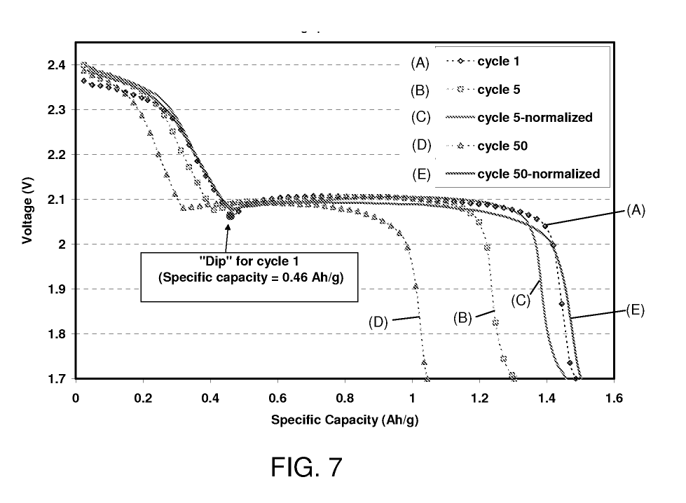

The discharge profiles of the 1st, 5th, and 50th cycles of a cell undergoing cycling under 98 Newtons per square centimeter of pressure are given by the broken lines with open symbols on FIG. 7. The “dip” between the high and low plateau regions of discharge profile of the 1st cycle occurs at a specific capacity of 0.46 Ah/g. The fact that this “dip” moves to the left for subsequent cycles without any substantial downward shift in the voltage plot indicates that the major reason for the decreasing specific capacity with increasing cycle number was the loss of active material—unreacted sulfide species—from active area of the cell either by diffusion or by movement of electrolyte. The afore-mentioned reason is supported by the fact that the surface of the lithium anode after 50 cycles did not show any deposits from the side reactions between lithium and cathode active material. By assuming that the “dip” between the high and low plateau regions occurred at same state of discharge as it did for the 1st discharge (i.e., at a specific capacity of 0.46 Ah/g of available S₈) the amount of available S₈ in the active area of the cell can be estimated for the subsequent cycles. The normalized discharge profiles—voltage vs. Ah/g of the estimated sulfur amounts—are plotted on FIG. 7 for 5th and 50th cycles. The fact that these normalized discharge profiles match well with the first discharge profiles further bolsters the assumption that the transfer of active material from the region between anode and cathode of the cell was the major reason for the observed capacity loss with cycling.

### Example 5

In this example, another set of electrochemical cells were tested. Slurries were made by dissolving 75% sulfur, 20% XE-2 carbon, 4% graphite, and 1% PVOH binder in solvents. The slurries were coated on aluminum foil primed with a conductive carbon layer and dried to make the cathode. The active material loading in the cathodes was 1.88 mg/cm². Pouch cells were made with the above-mentioned cathodes, separators, and lithium anodes. The active areas of the cathodes in the cells were 16.57cm². The electrolytes contained primarily dioxalane and di-methoxy ethane, with limited amounts of lithium bis(trifluoromethyl sulfonyl)imide, LiNO₃, Guanidine nitrate, and Pyridine nitrate. The discharge and charge currents used for cycling were 0.4 mA/cm² and 0.236 mA/cm², respectively. One set of cells was kept under a pressure of 98 Newtons per square centimeter by compressing the cells between two parallel metallic plates. The other set was cycled without compression. Table 7 outlines the cathode properties, and Table 8 outlines the cathode performance characteristics.

TABLE 7
Example 5 Cathode Properties

Applied Pressure

| | | 98 N/cm² |
|---|---|---|
| Cathode Parameter | 0 N/cm² | (=10 kg_{f}/cm²) |
| Thickness (microns) | 42 | 18 |
| Cathode porosity (%) | 71 | 32 |
| Void volume/g or S₈ (ml/g) | 1.60 | 0.31 |

TABLE 8
Example 5 Cathode Performance Characteristics

| | Applied Pressure | |
|---|---|---|
| | | 98 N/cm² |
| Cathode Parameter | 0 N/cm² | (=10 kg_{f}/cm²) |
| Discharge Capacity (1^{st} cycle) | 1130 mAh/g of S₈ | 237 mAh/g of S₈ |
| Discharge Capacity (10^{th} cycle) | 1110 mAh/g of S₈ | 247 mAh/g of S₈ |
| Charge Efficiency* (10^{th} cycle) | 97.22% | 100% |
| No. of cycles to stabilize capacity | 10 | 0 |

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. An electrochemical cell, comprising:
an anode comprising lithium as an anode active material, the anode having an active surface;
an electrolyte; and
a cathode comprising carbon and sulfur, wherein the electrochemical cell is capable of utilizing at least about 70% of the total sulfur in the cell through at least 2 charge and discharge cycles subsequent to a first charge and discharge cycle, wherein 100% utilization corresponds to 1675 mAh per gram of total sulfur in the electrochemical cell.

2. An electrochemical cell, comprising:
an anode comprising lithium as an anode active material, the anode having an active surface;
an electrolyte; and
a cathode comprising carbon and sulfur, wherein the electrochemical cell is capable of utilizing at least about 65% of the total sulfur in the cell through at least 10 charge and discharge cycles subsequent to a first charge and discharge cycle, wherein 100% utilization corresponds to 1675 mAh per gram of total sulfur in the electrochemical cell.

3. An electrochemical cell, comprising:
an anode comprising lithium as an anode active material, the anode having an active surface;
an electrolyte; and
a cathode comprising carbon and sulfur, wherein the electrochemical cell is capable of utilizing at least about 60% of the total sulfur in the cell through at least 50 charge and discharge cycles subsequent to a first charge and discharge cycle, wherein 100% utilization corresponds to 1675 mAh per gram of total sulfur in the electrochemical cell.

4. An electrochemical cell, comprising:
an anode comprising lithium as an anode active material, the anode having an active surface;
an electrolyte; and
a cathode comprising carbon and sulfur, wherein the electrochemical cell is capable of achieving a charge efficiency of at least about 80% during the first charge and discharge cycle and at least about 80% during the 10th charge and discharge cycle subsequent to the first charge and discharge cycle.

5. An electrochemical cell, comprising:
an anode comprising lithium as an anode active material, the anode having an active surface;
an electrolyte; and
a cathode comprising carbon and sulfur, wherein the electrochemical cell is capable of achieving a charge efficiency of at least about 80% during the first charging cycle and at least about 80% during the 50th charging cycle subsequent to the first charge and discharge cycle.

6. An electrochemical cell, comprising:
an anode comprising lithium as an anode active material, the anode having an active surface;
an electrolyte; and
a cathode comprising carbon and sulfur, wherein
the electrochemical cell is capable of utilizing at least about 65% of the total sulfur in the cell during a first charge and discharge cycle, wherein 100% utilization corresponds to 1675 mAh per gram of total sulfur in the electrochemical cell, and
the electrochemical cell capacity decreases by less than about 0.2% per charge and discharge cycle over at least 10 cycles subsequent to the first charge and discharge cycle.

7. An electrochemical cell, comprising:
an anode comprising lithium as an anode active material, the anode having an active surface;
an electrolyte; and
a cathode comprising carbon and sulfur,
wherein the ratio of the mass of electrolyte in the electrochemical cell to the mass of sulfur in the cathode is less than about 6:1, and
the electrochemical cell is capable of utilizing at least about 65% of the total sulfur in the cell, wherein 100% utilization corresponds to 1675 mAh per gram of total sulfur in the electrochemical cell.

8. An electrochemical cell, comprising:
an anode comprising lithium as an anode active material, the anode having an active surface;
an electrolyte; and
a cathode comprising carbon and sulfur,
wherein the cathode has an electrolyte accessible carbon area of at least about 1 m² per gram of sulfur in the cathode, and
the electrochemical cell is capable of utilizing at least about 65% of the total sulfur in the cell, wherein 100% utilization corresponds to 1675 mAh per gram of total sulfur in the electrochemical cell.

9. An electrochemical cell, comprising:
an anode comprising lithium as an anode active material, the anode having an active surface;
an electrolyte; and
a cathode comprising carbon and sulfur,
wherein the cathode has a porosity of at least about 30% during discharge of the electrochemical cell, and
the electrochemical cell is capable of utilizing at least about 65% of the total sulfur in the cell, wherein 100% utilization corresponds to 1675 mAh per gram of total sulfur in the electrochemical cell.

10. An electrochemical cell, comprising:
an anode comprising lithium as an anode active material, the anode having an active surface;
an electrolyte; and
a cathode comprising carbon and sulfur,
wherein the cathode has a void volume of at least about 1 cm³ per gram of sulfur in the cathode, and
the electrochemical cell is capable of utilizing at least about 65% of the total sulfur in the cell, wherein 100% utilization corresponds to 1675 mAh per gram of total sulfur in the electrochemical cell.

11. An electrochemical cell, comprising:
an anode comprising lithium as an anode active material, the anode having an active surface;
an electrolyte; and
a cathode comprising carbon and sulfur,
wherein the cathode contains less than about 20% binder by weight, and
the electrochemical cell is capable of utilizing at least about 65% of the total sulfur in the cell, wherein 100% utilization corresponds to 1675 mAh per gram of total sulfur in the electrochemical cell.

12. An electrochemical cell, comprising:
an anode comprising lithium as an anode active material, the anode having an active surface;
an electrolyte; and
a cathode comprising carbon and sulfur,
wherein the electrochemical cell is capable of achieving a current density of at least about 0.4 mA per square centimeter of the cathode surface during charge or discharge, and
the electrochemical cell is capable of utilizing at least about 65% of the total sulfur in the cell, wherein 100% utilization corresponds to 1675 mAh per gram of total sulfur in the electrochemical cell.

13. An electrochemical cell, comprising:
an anode comprising lithium as an anode active material, the anode having an active surface;
an electrolyte; and
a cathode comprising carbon and sulfur,
wherein the electrochemical cell is capable of achieving a current density of at least about 100 mA per gram of sulfur in the cathode during charge or discharge, and
the electrochemical cell is capable of utilizing at least about 65% of the total sulfur in the cell, wherein 100% utilization corresponds to 1675 mAh per gram of total sulfur in the electrochemical cell.

14. An electrochemical cell, comprising:
an anode comprising lithium as an anode active material, the anode having an active surface;
an electrolyte; and
a cathode comprising carbon and sulfur,
wherein the electrochemical cell is capable of utilizing at least about 65% of the total sulfur in the cell during the application of an anisotropic force with a component normal to the active surface of the anode defining a pressure of at least about 98 Newtons per square centimeter of the anode active surface, and 100% utilization corresponds to 1675 mAh per gram of total sulfur in the electrochemical cell.

15. An electrochemical cell, comprising:
an anode comprising lithium as an anode active material, the anode having an active surface;
an electrolyte; and
a cathode comprising carbon and sulfur,
wherein the electrochemical cell is capable of achieving a current density of at least about 0.4 mA per square centimeter of the cathode surface during charge or discharge, and
the ratio of the mass of electrolyte in the electrochemical cell to the mass of sulfur in the cathode is less than about 6:1.

16. An electrochemical cell, comprising:
an anode comprising lithium as an anode active material, the anode having an active surface;
an electrolyte; and
a cathode comprising carbon and sulfur,
wherein the electrochemical cell is capable of achieving a current density of at least about 0.4 mA per square centimeter of the cathode surface during charge or discharge, and
the cathode has an electrolyte accessible carbon area of at least about 1 m² per gram of sulfur in the cathode.

17. An electrochemical cell, comprising:
an anode comprising lithium as an anode active material, the anode having an active surface;
an electrolyte; and
a cathode comprising carbon and sulfur,
wherein the electrochemical cell is capable of achieving a current density of at least about 0.4 mA per square centimeter of the cathode surface during charge or discharge, and
the cathode has a porosity of at least about 30% during charge or discharge of the electrochemical cell.

18. An electrochemical cell, comprising:
an anode comprising lithium as an anode active material, the anode having an active surface;
an electrolyte; and
a cathode comprising carbon and sulfur,
wherein the electrochemical cell is capable of achieving a current density of at least about 0.4 mA per square centimeter of the cathode surface during charge or discharge, and
the cathode has a void volume of at least about 1 cm³ per gram of sulfur in the cathode.

19. An electrochemical cell, comprising:
an anode comprising lithium as an anode active material, the anode having an active surface;
an electrolyte; and
a cathode comprising carbon and sulfur,
wherein the cathode contains less than about 20% binder by weight, and
the electrochemical cell is capable of achieving a current density of at least about 0.4 mA per square centimeter of the cathode surface during discharge.

20. An electrochemical cell, comprising:
an anode comprising lithium as an anode active material, the anode having an active surface;
an electrolyte; and
a cathode comprising carbon and sulfur,
wherein the electrochemical cell is capable of achieving a current density of at least about 100 mA per gram of sulfur in the cathode during charge or discharge, and
the ratio of the mass of electrolyte in the electrochemical cell to the mass of sulfur in the cathode is less than about 6:1.

21. An electrochemical cell, comprising:
an anode comprising lithium as an anode active material, the anode having an active surface;
an electrolyte; and
a cathode comprising carbon and sulfur,
wherein the electrochemical cell is capable of achieving a current density of at least about 100 mA per gram of sulfur in the cathode during charge or discharge, and
the cathode has an electrolyte accessible carbon area of at least about 1 m² per gram of sulfur in the cathode.

22. An electrochemical cell, comprising:
an anode comprising lithium as an anode active material, the anode having an active surface;
an electrolyte; and
a cathode comprising carbon and sulfur,
wherein the electrochemical cell is capable of achieving a current density of at least about 100 mA per gram of sulfur in the cathode during charge or discharge, and
the cathode has a porosity of at least about 30% during charge or discharge of the electrochemical cell.

23. An electrochemical cell, comprising:
an anode comprising lithium as an anode active material, the anode having an active surface;
an electrolyte; and
a cathode comprising carbon and sulfur,
wherein the electrochemical cell is capable of achieving a current density of at least about 100 mA per gram of sulfur in the cathode during charge or discharge, and
the cathode has a void volume of at least about 1 cm³ per gram of sulfur in the cathode.

24. An electrochemical cell, comprising:
an anode comprising lithium as an anode active material, the anode having an active surface;
an electrolyte; and
a cathode comprising carbon and sulfur,
wherein the cathode contains less than about 20% binder by weight, and
the electrochemical cell is capable of achieving a current density of at least about 100 mA per gram of sulfur in the cathode during charge or discharge.

25. An electrochemical cell, comprising:
an anode comprising lithium as an anode active material, the anode having an active surface;
an electrolyte; and
a cathode comprising carbon and sulfur, wherein the cathode has an electrolyte accessible carbon area of at least about 1 m² per gram of sulfur in the cathode during the application of an anisotropic force with a component normal to the active surface of the anode defining a pressure of at least about 98 Newtons per square centimeter of the anode active surface.

26. An electrochemical cell, comprising:
an anode comprising lithium as an anode active material, the anode having an active surface;
an electrolyte; and
a cathode comprising carbon and sulfur, wherein the cathode has a porosity of at least about 30% during the application of an anisotropic force with a component normal to the active surface of the anode defining a pressure of at least about 98 Newtons per square centimeter of the anode active surface.

27. An electrochemical cell, comprising:
an anode comprising lithium as an anode active material, the anode having an active surface;
an electrolyte; and
a cathode comprising carbon and sulfur, wherein the cathode has a void volume of at least about 1 cm³ per gram of sulfur in the cathode during the application of an anisotropic force with a component normal to the active surface of the anode defining a pressure of at least about 98 Newtons per square centimeter of the anode active surface.

28. An electrochemical cell as in claim 1, wherein the lithium material comprises a lithium alloy.

29. An electrochemical cell as in claim 1, wherein an anisotropic force is applied uniformly over the active surface of the anode.

30. An electrochemical cell as in claim 1, wherein the electrochemical cell is cylindrical.

31. An electrochemical cell as in claim 1, wherein the electrochemical cell is in the shape of a triangular prism.

32. An electrochemical cell as in claim 1, wherein the electrochemical cell is in the shape of a rectangular prism.

33. An electrochemical cell as in claim 1, further comprising a porous separator between the anode and the cathode.

34. An electrochemical cell as in claim 1, further comprising a separator, permeable to the electrolyte, between the anode and the cathode.

35. An electrochemical cell as in claim 1, wherein an anisotropic force is applied using compression springs.

36. An electrochemical cell as in claim 1, wherein an anisotropic force is applied using Belleville washers.

37. An electrochemical cell as in claim 1, wherein an anisotropic force is applied using a pneumatic device.

38. An electrochemical cell as in claim 2, wherein the electrochemical cell is capable of utilizing at least about 70% of the total sulfur in the cell through at least 2 charge and discharge cycles subsequent to a first charge and discharge cycle.

39-43. (canceled)

44. An electrochemical cell as in claim 1, wherein the electrochemical cell is capable of utilizing at least about 65% of the total sulfur in the cell through at least 10 charge and discharge cycles subsequent to a first charge and discharge cycle.

45-60. (canceled)

61. An electrochemical cell as in claim 1, wherein the electrochemical cell is operated at a discharge current density of at least about 0.1 mA/cm² of the cathode surface.

62-63. (canceled)

64. An electrochemical cell as in claim 1, wherein the discharge current is at least about 100 mA per gram of sulfur in the cathode.

65-68. (canceled)

69. An electrochemical cell as in claim 1, wherein the electrochemical cell capacity decreases by less than about 0.2% per charge and discharge cycle over at least about 2 cycles subsequent to a first charge and discharge cycle.

70-75. (canceled)

76. An electrochemical cell as in claim 1, wherein the electrochemical cell achieves a charge efficiency of at least about 60% for the first cycle.

77-115. (canceled)

116. An electrochemical cell as in claim 1, wherein the electrochemical cell is capable of achieving the performance during the application of an anisotropic force with a component normal to the active surface of the anode defining a pressure of at least about 4.9 Newtons per square centimeter of the anode active surface.

117-124. (canceled)

125. An electrochemical cell as in claim 1, wherein the ratio of the mass of electrolyte in the electrochemical cell to the mass of sulfur in the cathode is less than about 6:1

126-128. (canceled)

129. An electrochemical cell as in claim 1, wherein the cathode has an electrolyte accessible carbon area of at least about 1 m² per gram of sulfur in the cathode.

130-134. (canceled)

135. An electrochemical cell as in claim 1, wherein the cathode has a porosity of at least about 30% during discharge of the electrochemical cell.

136-141. (canceled)

142. An electrochemical cell as in claim 1, wherein the cathode has a void volume of at least about 1 cm³ per gram of sulfur in the cathode.

143-145. (canceled)

146. An electrochemical cell as in claim 1, wherein the cathode contains less than about 20% binder by weight.

147-156. (canceled)

157. A method of making an electrochemical cell, comprising:
providing a cathode comprising sulfur;
providing an anode comprising lithium, the anode having an active surface;
applying an anisotropic force component normal to the active surface of the anode; and
subsequent to the application of the anisotropic force component, adding a fluid electrolyte such that the electrolyte is in electrochemical communication with the cathode and the anode.

158-166. (canceled)
